(19) United States
(12) Patent Application Publication
(10) Pub. No.: US 2016/0139314 A1
(43) Pub. Date: May 19, 2016

(54) RETARDATION FILM, METHOD FOR MANUFACTURING RETARDATION FILM, POLARIZING PLATE AND IMAGE DISPLAY DEVICE WHICH USE RETARDATION FILM, AND 3D IMAGE DISPLAY SYSTEM USING IMAGE DISPLAY DEVICE

(71) Applicant: DAI NIPPON PRINTING CO., LTD., Tokyo (JP)

(72) Inventors: Yuya INOMATA, Tokyo (JP); Ryohei YOSHIDA, Tokyo (JP); Yosuke KOSAKA, Tokyo (JP); Kenji FUJITA, Tokyo (JP)

(73) Assignee: DAI NIPPON PRINTING CO., LTD., Tokyo (JP)

(21) Appl. No.: 14/902,993

(22) PCT Filed: Jul. 24, 2014
(86) PCT No.: PCT/JP2014/069543

§ 371 Date: Jan. 5, 2016

(30) Foreign Application Priority Data
Jul. 24, 2013 (JP) 2013-153446
Jul. 25, 2013 (JP) 2013-154219
Sep. 11, 2013 (JP) 2013-188203
Sep. 11, 2013 (JP) 2013-188204
Jan. 8, 2014 (JP) 2014-001868
Jan. 8, 2014 (JP) 2014-001869

(51) Int. Cl. G02B 5/30; G02B 1/11

(52) U.S. Cl. CPC G02B 5/3083; G02B 1/11; G02B 5/3016

(57) ABSTRACT

In order to make it possible to effectively suppress interference fringes which occur due to the difference in refractive index between a retardation layer and a pattern alignment layer while maintaining an alignment property in a retardation film, a retardation film includes a substrate, an alignment layer containing a photo-alignment material, and a retardation layer containing a liquid crystal compound, and the alignment layer contains 3.0-8.0 parts by mass (inclusive) of epoxy monomer with respect to 100 parts by mass of photo-alignment material.

### TECHNICAL FIELD

The present invention relates to a retardation film which includes a substrate, an alignment layer, and a retardation layer that contains a liquid crystal compound, a method for manufacturing the same, and an image display device and the like using the same.

### BACKGROUND ART

Recently, flat panel displays capable of displaying images three-dimensionally have been provided. Here, for a flat panel display to display images three-dimensionally, generally, it is necessary to provide a right-eye image and a left-eye image selectively to the right and left eyes of a viewer according to a certain method. As a method of selectively providing a right-eye image and a left-eye image, a passive method is known, for example. This passive three-dimensional display method will be described with reference to the drawing. FIG. 13 is a schematic diagram illustrating an example of passive three-dimensional display which uses a liquid crystal display panel. In the example of FIG. 13, pixels arranged continuously in a vertical direction of a liquid crystal display panel are sequentially and alternately allocated to right-eye pixels for displaying a right-eye image and left-eye pixels for displaying a left-eye image and are driven based on right-eye and left-eye image data, respectively. In this way, the right-eye image and the left-eye image are displayed simultaneously. Due to this, the screen of the liquid crystal display panel is divided alternately into a region for displaying the right-eye image and a region for displaying the left-eye image by a stripe-shaped region of which the short sides extend in a vertical direction and the long sides extend in a horizontal direction.

Further, according to the passive method, a patterned retardation film which is a retardation film having a patterned retardation layer is disposed on a panel surface of a liquid crystal display panel, and an output beam which is a linearly polarized beam from the right-eye and left-eye pixels is converted to circularly polarized beams of which the rotation direction for the right eye is different from that of the left eye. Thus, two stripe-shaped regions of which the slow axis directions (the directions in which the refractive index is the largest) are orthogonal are formed sequentially and alternately on the patterned retardation film so as to correspond to a setting of regions in the liquid crystal display panel. Thus, in the passive method, a viewer wears glasses having the corresponding polarizing filter so that the right-eye image and the left-eye image are selectively provided to the right and left eyes of the viewer. Here, the angles between the horizontal direction and the slow axis directions of the adjacent stripe-shaped regions are generally +45° and −45° or 0° and 90°. In the example of FIG. 13, the long-side direction of the screen is depicted as a horizontal direction according to the notation of a general image display device.

This passive method can be applied to a liquid crystal display panel having a low response speed and can display images three-dimensionally with a simple structure using a patterned retardation film and circularly polarizing glasses.

A patterned retardation film according to this passive method requires a patterned retardation layer that gives retardation to a transmission beam so as to correspond to allocation of pixels. With regard to the patterned retardation film, Patent Document 1 discloses a method of forming a photo-alignment layer of which the alignment regulation force is controlled on a glass substrate and patterning an arrangement of liquid crystals using the photo-alignment layer to form a retardation layer. Moreover, Patent Document 2 discloses a method of forming a photo-alignment layer by performing exposure treatment using a mask after an entire surface is subjected to exposure treatment, aligning a liquid crystal layer by alignment regulation force of the photo-alignment layer, and curing the liquid crystal layer to form a patterned retardation film.

Moreover, various antireflection methods are employed in so-called polarizing plate surface material used in various displays. As one of the antireflection methods, a method of forming a thin film having a low refractive index (so-called a clear antireflection surface material) on one surface of a transparent substrate to form a clear antireflection layer having a low haze value (cloudiness) of 0.5% or lower to secure transparency and reduce reflectance is employed. Regarding antireflection based on the clear antireflection surface material, various measures are proposed in Patent Document 3 and the like. In the antireflection method based on the clear surface material, a surface film formed of a material having a low refractive index is formed on a target surface to realize antireflection by reducing the amount of reflected light using interference between the light reflected from a front surface of the surface layer and the light reflected from the lower layer of the surface layer.

However, in an optical film such as a patterned retardation film (hereinafter referred to as a “retardation film”), since the difference in refractive index between the retardation layer and an alignment layer is large, an unevenness may occur due to thin film interference occurring due to the difference in refractive index and interference fringes may occur. Due to this, a retardation film capable of effectively suppressing interference fringes occurring due to a difference in refractive index among the retardation layer, the substrate, and the alignment layer is required.

In order to prevent the occurrence of interference fringes, for example, Patent Document 4 discloses an optical film in which a hard coat layer and a low refractive index layer are provided on the other surface of a transparent substrate to alleviate an interference unevenness resulting from a refractive index difference and a film thickness unevenness. Moreover, although a method of adding an additive to adjust the refractive index has been proposed, this method has a problem that an alignment property of the film deteriorates. Thus, a retardation film capable of suppressing the occurrence of interference fringes while maintaining an alignment property is required.

Moreover, in an optical film such as a patterned retardation film, when antireflection is realized by forming a clear antireflection layer on one surface of a transparent substrate, it is possible to display high-quality images by placing the optical film on an image display panel. However, when a clear antireflection layer is applied to an optical film such as a patterned retardation film to realize antireflection, as compared to when an antiglare layer (also referred to as antiglare (AG) and generally having a haze value of 1.0% or higher) which is another example of an antireflection layer is formed, interference fringes resulting from a thin film interference between the retardation layer and the transparent substrate is easily noticed. Thus, even when antireflection is realized by forming a clear antireflection layer, a retardation film capable of effectively suppressing the occurrence of such interference fringes is required.

Patent Document 1: Japanese Unexamined Patent Application, Publication No. 2005-049865

Patent Document 2: Japanese Unexamined Patent Application, Publication No. 2012-042530

Patent Document 3: Japanese Unexamined Patent Application, Publication No. 2007-272132

Patent Document 4: Japanese Unexamined Patent Application, Publication No. 2012-237928

### DISCLOSURE OF THE INVENTION

### Problems to be Solved by the Invention

The present invention has been made in view of the above-described problems and an object thereof is to provide a retardation film capable of effectively suppressing interference fringes occurring due to a difference in refractive index between a retardation layer and an alignment layer while maintaining an alignment property.

Another object of the present invention is to provide a retardation film capable of effectively suppressing interference fringes occurring due to a difference in refractive index between a retardation layer and a substrate or between a pattern alignment layer and a film.

Still another object of the present invention is to provide an optical film such as a patterned retardation film capable of effectively suppressing the occurrence of interference fringes even when antireflection is realized by forming a clear antireflection layer.

### Means for Solving the Problems

As the result of intensive investigation to solve the above-described problems, the present inventors have accomplished the present invention by finding that the occurrence of interference fringes can be suppressed effectively while maintaining an alignment property of an alignment layer when the alignment layer contains an epoxy monomer having a high refractive index in a predetermined proportion.

Moreover, the present inventors have accomplished the present invention by finding that the interference fringes can be suppressed effectively even when antireflection is realized by forming a clear antireflection layer when a retardation layer contains an alkoxysilane which is a low refractive index material in a predetermined proportion.

Further, the present inventors have accomplished the present invention by finding that the interference fringes can be suppressed effectively even when antireflection is realized by forming a clear antireflection layer when a retardation layer contains predetermined fine particles having a low refractive index. That is, the present invention provides the following inventions.

(1) A retardation film including: a substrate, an alignment layer that contains a photo-alignment material, and a retardation layer that contains a liquid crystal compound, wherein the alignment layer contains an epoxy monomer having a refractive index of 1.60 or more in a proportion of between 3.0 parts by mass and 8.0 parts by mass with respect to 100 parts by mass of the photo-alignment material.

(2) The retardation film described in (1), wherein the refractive index of the epoxy monomer is 1.70 or more.

(3) The retardation film described in (1) or (2), wherein an in-plane variation of an optical axis defined by a standard deviation (σ) when the optical axis was measured is smaller than 1.5.

(4) The retardation film described in any one of (1) to (3), wherein the alignment layer has an alignment pattern.

(5) A polarizing plate including the retardation film described in any one of (1) to (4).

(6) An image display device including the retardation film described in any one of (1) to (4).

(7) A 3D image display system including the image display device described in (6).

(8) A method for manufacturing a retardation film including a substrate, an alignment layer that contains a photo-alignment material, and a retardation layer that contains a liquid crystal compound, wherein the alignment layer is formed by coating an alignment layer composition that contains an epoxy monomer having a refractive index of 1.60 or more in a proportion of between 3.0 parts by mass and 8.0 parts by mass with respect to 100 parts by mass of the photo-alignment material on the substrate and curing the alignment layer composition.

(9) A retardation film including: a substrate, an alignment layer, and a retardation layer that contains a liquid crystal compound, wherein the retardation layer contains an alkoxysilane in a proportion of between 2.0 parts by mass and 14.0 parts by mass with respect to 100 parts by mass of the liquid crystal compound.

(10) The retardation film described in (9), wherein the refractive index of the alkoxysilane is 1.50 or smaller.

(11) The retardation film described in (9) or (10), wherein an in-plane variation of an optical axis defined by a standard deviation (σ) when the optical axis was measured is smaller than 1.5.

(12) The retardation film described in any one of (9) to (11), wherein the alignment layer has an alignment pattern.

(13) A polarizing plate including the retardation film described in any one of (9) to (12).

(14) An image display device including the retardation film described in any one of (9) to (12).

(15) A 3D image display system including the image display device described in (14).

(16) A method for manufacturing a retardation film including a substrate, an alignment layer, and a retardation layer that contains a liquid crystal compound, wherein the retardation layer is formed by coating a liquid crystal composition that contains an alkoxysilane in a proportion of between 2.0 parts by mass and 14.0 parts by mass with respect to 100 parts by mass of the liquid crystal compound on the alignment layer and curing the liquid crystal composition.

(17) A retardation film in which an antireflection layer, a transparent substrate, an alignment layer, and a retardation layer that contains polymerizable liquid crystals are sequentially stacked in that order, and the retardation layer provides a retardation to transmission light, wherein

the antireflection layer is a clear antireflection layer of which the haze value based on JIS K7105 is 0.5% or smaller, and

the retardation layer contains fine particles having a refractive index lower than a refractive index of the polymerizable liquid crystals.

According to the retardation film of (17), it is possible to decrease the refractive index of the retardation layer with the aid of the fine particles so as to be close to the refractive index of the transparent substrate and to suppress the occurrence of interference fringes.

(18) The retardation film described in (17), wherein the refractive index of the fine particles is between 1.3 and 1.7.

According to the retardation film of (18), it is possible to suppress the occurrence of interference fringes more effectively.

(19) The retardation film described in (17) or (18), wherein an average particle size of the fine particles is larger than a thickness of the retardation layer.

According to the retardation film of (19), since it is possible to form an uneven surface on the surface of the retardation layer to scatter reflected light, it is possible to suppress the occurrence of interference fringes more effectively.

(20) The retardation film described in any one of (17) to (19), wherein the fine particles are silica, and a content of the fine particles in the retardation layer is between 0.01 mass % and 10 mass %.

According to the retardation film of (20), since it is possible to obtain a desired refractive index and to form an uneven surface, it is possible to suppress the occurrence of interference fringes more effectively.

(21) The retardation film described in any one of (17) to (20), wherein a surface roughness Ra of the retardation layer is between 3 nm and 200 nm.

According to the retardation film of (21), since it is possible to form a desired uneven surface, it is possible to suppress the occurrence of interference fringes more effectively.

(22) The retardation film described in any one of (17) to (21), wherein the transparent substrate is an acrylic resin and has a thickness of 80 μm or smaller.

According to the retardation film of (22), since the thickness is as small as 80 μm or smaller, the retardation layer of the patterned retardation film is close to the liquid crystal display panel, and the viewing angle of 3D images can be extended.

(23) The retardation film described in any one of (17) to (22), wherein the alignment layer has an alignment pattern.

(24) A polarizing plate including the retardation film described in any one of (17) to (23).

According to the polarizing plate (24), when the retardation film is directly bonded to a polarizer, by adjusting the refractive index of the retardation layer, it is possible to reduce interfacial reflections between the retardation layer and an adhesion layer of the polarizer and to suppress interference fringes.

(25) An image display device including the retardation film described in any one of (17) to (23).

(26) A 3D image display system including an image display device described in (25).

When the transparent substrate is thin, interference fringes are more likely to be visible due to the interface between the retardation layer and the film, in particular. However, according to the image display device of (25) or (26), by adding fine particles to decrease the refractive index of the retardation layer to be close to the refractive index of the transparent substrate, it is possible to provide an image display device and a 3D image display system capable of suppressing the occurrence of interference fringes.

(27) A retardation film in which an antireflection layer, a retardation layer that contains polymerizable liquid crystals, an alignment layer, and a transparent substrate are sequentially stacked in that order, and the retardation layer provides a retardation to transmission light, wherein the antireflection layer is a clear antireflection layer of which the haze value based on JIS K7105 is 0.5% or smaller, and

the retardation layer contains fine particles having a refractive index lower than a refractive index of the polymerizable liquid crystals.

According to (27), it is possible to decrease the refractive index of the retardation layer with the aid of the fine particles so as to be close to the refractive index of the transparent substrate and to suppress the occurrence of interference fringes.

(28) A retardation film in which an antireflection layer, a transparent substrate, an alignment layer, and a retardation layer that contains polymerizable liquid crystals are sequentially stacked in that order, and the retardation layer provides a retardation to transmission light, wherein

the antireflection layer is a clear antireflection layer of which the haze value based on JIS K7105 is 0.5% or smaller, and

when n₁ is the refractive index of the transparent substrate, n₂ is the refractive index of the alignment layer, and n₃ is the refractive index of the retardation layer,
n₁<n₂<n₃, and
for n_{AvE}=(n₁+n₃)/2, which is an average value of n₁ and n₃, n_{AVE}+0.01>n₂>n_{AVE}−0.01.

According to (28), the refractive index of the alignment layer is adjusted to approximately an intermediate value between the refractive index of the transparent substrate and the refractive index of the retardation layer. In this way, the occurrence of interference fringes can be suppressed.

(29) The retardation film described in (28), wherein the transparent substrate is an acrylic resin having a thickness of 80 μm or smaller.

According to (29), since the thickness is as small as 80 μm or smaller, the retardation layer of the patterned retardation film is close to the liquid crystal display panel, and the viewing angle of 3D images can be extended.

(30) The retardation film described in (28) or (29), wherein the refractive index n₂ of the alignment layer is between 1.53 and 1.56.

According to (30), the occurrence of interference fringes can be suppressed particularly effectively when the transparent substrate is an acrylic resin and has a refractive index of approximately 1.50.

(31) The retardation film described in any one of (28) to (30), wherein the alignment layer is formed of a photodimerizable polymer material.

According to (31), by selecting the refractive index of the photodimerizable polymer material, it is possible to suppress the occurrence of interference fringes.

(32) The retardation film described in any one of (28) to (31), wherein the alignment layer contains a photodimerizable polymer material and an additive for adjusting a refractive index.

According to (32), it is possible to obtain a desired refractive index with the aid of an additive in addition to the refractive index of the photodimerizable polymer material.

(33) The retardation film described in any one of (28) to (32), wherein the alignment layer has an alignment pattern.

(34) A polarizing plate including the retardation film described in any one of (28) to (33).

(35) An image display device including the retardation film described in any one of (28) to (33).

According to (35), the refractive index of the alignment layer is adjusted to approximately an intermediate value between the refractive index of the transparent substrate and the refractive index of the retardation layer. In this way, the occurrence of interference fringes can be suppressed.

(36) A 3D image display system including the image display device described in (35).

(37) A retardation film in which an antireflection layer, a retardation layer that contains polymerizable liquid crystals, an alignment layer, and a transparent substrate are sequentially stacked in that order, and the retardation layer provides a retardation to transmission light, wherein

the antireflection layer is a clear antireflection layer of which the haze value based on JIS K7105 is 0.5% or smaller, and

when n₁ is the refractive index of the transparent substrate, n₂ is the refractive index of the alignment layer, and n₃ is the refractive index of the retardation layer,
n₁<n₂<n₃, and
for n_{AvE}=(n₁+n₃)/2, which is an average value of n₁ and n₃, n_{AVE}+0.01>n₂>n_{AVE}−0.01.

According to (37), the refractive index of the alignment layer is adjusted to approximately an intermediate value between the refractive index of the transparent substrate and the refractive index of the retardation layer. In this way, the occurrence of interference fringes can be suppressed.

### Effects of the Invention

According to the present invention, since the alignment layer contains an epoxy monomer in a predetermined proportion, it is possible to effectively suppress interference fringes occurring due to a difference in refractive index between films while maintaining a satisfactory alignment property.

Moreover, according to the present invention, since the retardation layer contains an alkoxysilane in a predetermined proportion, it is possible to suppress interference fringes occurring due to a difference in refractive index between films. Further, even when an additive is added to the retardation layer in the above-described manner, it is possible to effectively suppress interference fringes while maintaining a satisfactory alignment property.

In addition, according to the present invention, even when a clear antireflection layer is formed to realize antireflection, it is possible to suppress the occurrence of interference fringes.

### BRIEF DESCRIPTION OF THE DRAWINGS

FIG. 1 is a schematic diagram illustrating an example of a patterned retardation film.

FIG. 2 is a schematic diagram illustrating an example of a pattern alignment layer.

FIG. 3 is a schematic diagram illustrating an example of the steps of manufacturing a patterned retardation film.

FIGS. 4A and 4B are diagrams schematically illustrating a method of forming an alignment pattern according to a photo-alignment method.

FIG. 5 is a schematic diagram illustrating an example of a patterned retardation film according to a second embodiment.

FIG. 6 is a schematic diagram illustrating an example of a patterned retardation film according to a third embodiment.

FIG. 7 is a schematic diagram illustrating an example of the steps of manufacturing a patterned retardation film.

FIG. 8 is an enlarged cross-sectional view of FIG. 6.

FIG. 9 is an enlarged cross-sectional view illustrating a patterned retardation film according to another example.

FIG. 10 is a schematic diagram illustrating an example of a patterned retardation film according to a fourth embodiment.

FIGS. 11A and 11B are enlarged cross-sectional views of FIG. 10.

FIG. 12 is an enlarged cross-sectional view illustrating a patterned retardation film according to another example.

FIG. 13 is a diagram for describing three-dimensional image display based on a passive method.

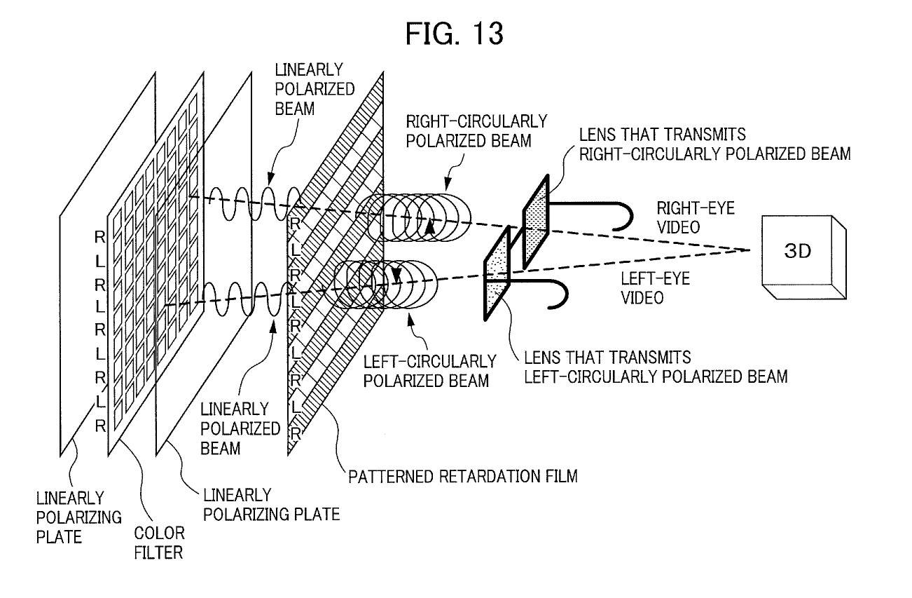

### PREFERRED MODE FOR CARRYING OUT THE INVENTION

Hereinafter, specific embodiments (hereinafter referred to as “present embodiments”) of the present invention will be described in detail with reference to the drawings. The present invention is not limited to the following embodiments but various changes can be made without departing from the spirit and scope of the present invention.

### First Embodiment

### Image Display Device and Image Display System

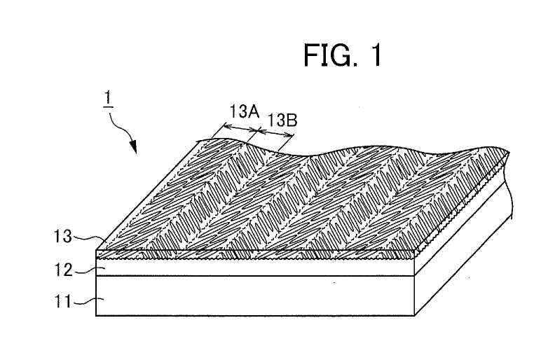

FIG. 1 is a diagram illustrating a patterned retardation film employed in an image display device according to a first embodiment of the present invention. In the image display device according to the first embodiment, pixels of a liquid crystal display panel arranged continuously in a vertical direction (the direction corresponding to a left-right direction in FIG. 1) are sequentially and alternately allocated to right-eye pixels for displaying a right-eye image and left-eye pixels for displaying a left-eye image and are driven based on right-eye and left-eye image data. Due to this, a display screen of the image display device is alternately divided into a stripe-shaped region for displaying the right-eye image and a stripe-shaped region for displaying the left-eye image, and the right-eye image and the left-eye image are displayed simultaneously. The image display device has a patterned retardation film 1 disposed on a panel surface (a viewer-side surface) of the liquid crystal display panel, and the patterned retardation film 1 gives retardations corresponding to the output beams from the right-eye and left-eye pixels. In this way, the image display device displays a desired stereoscopic image according to a passive method. Moreover, in a 3D embodiment according to this embodiment, video contents associated with 3D image display is provided by a desired source and is displayed on the image display device, and a viewer wears the corresponding circularly polarizing glasses and sees 3D video contents. Although it is assumed that a liquid crystal display panel is employed in the image display device, a linearly polarizing plate may be bonded to an output surface of the liquid crystal display panel so that the image display device includes a patterned retardation film.

### 1-1. Configuration of Retardation Film

The patterned retardation film 1 is a retardation film having a patterned retardation layer and includes a substrate 11, a pattern alignment layer 12 which is an alignment layer having an alignment pattern, and a retardation layer 13 that contains a liquid crystal compound. In the patterned retardation film 1, the pattern alignment layer 12 contains an epoxy monomer having a high refractive index in a predetermined proportion.

### [Substrate]

The substrate 11 is a transparent film substrate and has a function of supporting the pattern alignment layer 12 and has a long shape.

The substrate 11 preferably has small retardation, and an in-plane retardation value (hereinafter also referred to as “Re value”) is preferably between 0 nm and 10 nm, and more preferably between 0 nm and 5 nm, and further preferably between 0 nm and 3 nm. If the Re value exceeds 10 nm, it is undesirable because the display quality of a flat panel display which uses a pattern alignment layer may deteriorate.

The Re value is an index indicating the degree of birefringence in an in-plane direction of a refractive index anisotropic member. When Nx is a refractive index in a slow axis direction in which the refractive index in the in-plane direction is the largest, Ny is a refractive index in a fast axis direction orthogonal to the slow axis direction, and d is a thickness in a direction vertical to the in-plane direction of the refractive index anisotropic member, the Re value is expressed by the following equation.

Re [nm]=(Nx−Ny)×d [nm]

The Re value can be measured according to a parallel-nicols rotation method using a retardation measurement apparatus KOBRA-WR (produced by Oji Scientific Instruments), for example. Moreover, in the present specification, it is assumed that the Re value means a value at a wavelength of 589 nm unless particularly stated otherwise.

The transmittance of the substrate 11 in the visible range is preferably 80% or higher and more preferably 90% or higher. Here, the transmittance of the transparent film substrate can be measured by JIS K7361-1 (a test method of total luminous transmittance of plastics-transparent materials). Examples of such a flexible material include acrylic polymers, cellulose derivatives, norbornene polymers, cyclo-olefin polymers, polymethyl methacrylate, polyvinyl alcohol, polyimide, polyarylate, polyethylene terephthalate, polysulfone, polyether sulfone, amorphous polyolefin, polystyrene, epoxy resins, polycarbonate, polyesters, and the like.

Among these films, the cellulose derivatives are preferred because a pattern alignment layer having an excellent optical isotropy and an excellent optical property can be manufactured. Specifically, although the cellulose derivatives are not particularly limited, cellulose esters are preferably used and cellulose acylates are more preferably used because these cellulose derivatives are used in a broad range of industrial fields and are readily available.

Lower fatty acid esters having 2 to 4 carbon atoms are preferable as the cellulose acylates. The lower fatty acid esters may include only one lower fatty acid ester such as cellulose acetate and may include a plurality of fatty acid esters such as cellulose acetate butyrate or cellulose acetate propionate.

Among lower fatty acid esters, cellulose acetate can be particularly ideally used. TAC having an average degree of acetylation of 57.5% to 62.5% (degree of substitution: 2.6 to 3.0) is most preferably used as the cellulose acetate. Here, the degree of acetylation means the amount of a combined acetic acid per unit mass of cellulose. The degree of acetylation can be obtained by measuring and calculating the degree of acetylation according to ASTM: D-817-91 (a test method for cellulose acetate or the like). The degree of acetylation of TAC can be obtained by the above-described method after removing impurities such as plasticizer contained in the film.

Moreover, the refractive index of the acrylic polymer (acrylic substrate) such as PMMA is approximately 1.40 to 1.60 and exhibits no change in a thickness direction of the substrate, and the dependence on humidity of a dimensional contraction factor is low. Thus, it is possible to reduce the film thickness as compared to TAC, for example, and to increase the viewing angle of a 3D panel.

The thickness of the substrate 11 is not particularly limited as long as the thickness is within a range where a necessary self-supporting property can be provided to the retardation film depending on the use or the like of the retardation film formed using the pattern alignment layer. The thickness of the substrate 11 is generally preferably in the range of 25 μm and 125 μm, and more preferably in the range of 40 μm and 100 μm, and further preferably in the range of 40 μm and 80 μm. If the thickness is smaller than 25 μm, it is undesirable because a necessary self-supporting property is not provided to the retardation film. If the thickness exceeds 125 μm, it is undesirable because, in a case where the retardation film has an long shape, when a plurality of sheets of retardation films are obtained by cutting and machining the long retardation film, processing waste may increase and the cutting blade may be worn fast.

The substrate 11 is not limited to the configuration where the substrate includes only one layer, but the substrate 11 may have a configuration in which a plurality of layers are stacked. When the substrate 11 has a configuration in which a plurality of layers are stacked, the layers having the same composition may be stacked or the layers having different compositions may be stacked.

### [Pattern Alignment Layer]

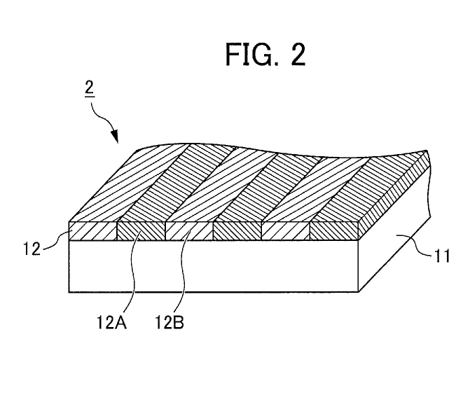

FIG. 2 is a schematic diagram of the pattern alignment layer 2. The pattern alignment layer 2 is formed of a cured material obtained by coating a pattern alignment layer composition (alignment layer composition) on the substrate 11 and curing the same, and the pattern alignment layer 12 is formed by the pattern alignment layer 2.

The pattern alignment layer 2 has two alignment patterns (first and second alignment regions 12A and 12B) which are arranged alternately. The alignment patterns of the pattern alignment layer 2 can be formed according to a photo-alignment method of realizing alignment based on irradiation of light using a photo-alignment material that exhibits a photo-alignment property when irradiated with polarized light and form the pattern alignment layer 12. The pattern alignment layer 12 may be formed according to a UV molding method of applying an UV-curable resin to the substrate 11, transferring an alignment pattern to the surface of the UV-curable resin using a molding mold having an alignment pattern having a micro-uneven shape, and then curing the UV-curable resin.

When the pattern alignment layer 12 is formed according to the photo-alignment method, the pattern alignment layer 12 contains a pattern alignment layer composition (alignment layer composition), and the alignment layer composition contains a photo-alignment material that exhibits a photo-alignment property when irradiated with polarized light.

### (Photo-Alignment Material)

Here, the photo-alignment material means a material that can exhibit an alignment regulation force when irradiated with polarized UV light. The alignment regulation force means a function of aligning a polymerizable liquid crystal compound (also referred to as a “rod-like compound”) in a predetermined direction when an alignment layer containing a photo-alignment material is formed and a layer formed of the rod-shaped compound (the retardation layer 13) is formed on the alignment layer.

The photo-alignment material is not particularly limited if the material exhibits an alignment regulation force when irradiated with polarized light. The photo-alignment materials may be roughly classified into a photo-isomerization material which reversibly changes the alignment regulation force by changing the molecular shape only according to cis-trans transformation and a photoreactive material which changes the molecule itself by irradiation of polarized light. In the patterned retardation film 1, although either the photo-isomerization material or the photoreactive material can be appropriately used, the photoreactive material is more preferably used. Since the photoreactive material exhibits an alignment regulation force when molecules react upon being irradiated with polarized light, the photoreactive material can irreversibly exhibit the alignment regulation force. Thus, the photoreactive material is excellent in temporal stability of the alignment regulation force.

Moreover, the photoreactive material can be classified into a photodimerizable material that exhibits an alignment regulation force based on photodimerization, a photolysis material that exhibits an alignment regulation force based on photolysis, a photo-coupling material that exhibits an alignment regulation force based on photo-coupling, a photolysis-coupling material that exhibits an alignment regulation force based on photolysis and photo-coupling, and the like. In the patterned retardation film 1, although any one of the above-mentioned photoreactive materials can be appropriately used, the photodimerizable material is preferably used.

Although the photodimerizable material is not particularly limited as long as the material can exhibit an alignment regulation force based on photodimerization, in order to obtain a satisfactory alignment regulation force, the wavelength of light at which photodimerization occurs is preferably 280 nm or more, and more preferably, is in the range of 280 nm and 400 nm, and further preferably, is in the range of 300 nm and 380.

Examples of the photodimerizable material include polymers having cinnamate, coumarin, benzylidene phthalimidine, benzylidene acetophenone, diphenylacetylene, stilbazole, uracil, quinolinone, maleic imide, or a cinnamylidene acetic acid derivative. Among these materials, in order to obtain a satisfactory alignment regulation force, polymers containing one or both of cinnamate and coumarin are preferably used. Specific examples of such a photodimerizable material include compounds disclosed in Japanese Unexamined Patent Application, Publication No. H9-118717, Japanese Unexamined Patent Application, Publication No. H10-506420, Japanese Unexamined Patent Application, Publication No. 2003-505561, and WO 2010/150748.

The photo-alignment material used in the present embodiment may include only one type of the photo-alignment material or may include two or more types of the photo-alignment materials.

### (High Refractive Index Material)

Here, the refractive index of an alignment layer that forms a general pattern alignment layer is generally approximately 1.54. On the other hand, the refractive index of polymerizable liquid crystals is approximately between 1.55 and 1.75, which is higher than the refractive index of the pattern alignment layer. Thus, due to a difference in refractive index between the pattern alignment layer and the retardation layer, an unevenness may occur based on thin film interference between the retardation layer and the substrate and interference fringes may occur.

Thus, in the patterned retardation film 1 according to the present embodiment, the pattern alignment layer 12 contains a high refractive index material (specifically, an epoxy monomer having a high refractive index, which does not contribute to alignment of liquid crystal compounds even when exposed to polarized light) in a predetermined proportion. Such a pattern alignment layer 12 can be obtained by including an epoxy monomer in a predetermined proportion in an alignment layer composition together with a photo-alignment material and coating the substrate 11 using the alignment layer composition.

In the patterned retardation film 1, since the pattern alignment layer 12 contains an epoxy monomer having a high refractive index in a predetermined proportion, it is possible to effectively increase the refractive index of the pattern alignment layer 12 and to suppress the occurrence of interference fringes due to a difference in refractive index between the pattern alignment layer 12 and the retardation layer 13. In this way, it is possible to effectively suppress interference fringes without narrowing the width of choice of the materials that form the pattern alignment layer 12 and the retardation layer 13.

Further, the epoxy monomer does not affect the alignment property of the liquid crystal compounds of the retardation layer 13 even when added to the pattern alignment layer 12. Thus, it is possible to effectively suppress interference fringes while maintaining a satisfactory alignment property without disordering the alignment. Specifically, the patterned retardation film 1 is a retardation film which maintains a satisfactory alignment property in which the standard deviation (σ) of an in-plane variation in an optical axis in a very small region when the optical axis was measured is smaller than 1.5. A variation in the optical axis can be defined by a standard deviation (σ) (unit: °) of the optical axis.

Although the epoxy monomer is not particularly limited, a bifunctional epoxy monomer having a fluorene skeleton which is a compound (specifically, represented by Formula (1)) disclosed in Japanese Unexamined Patent Application, Publication No. 2012-102228, for example.

Specifically, the high refractive index epoxy monomer has a refractive index of 1.60 or more. Moreover, the refractive index of the epoxy monomer is preferably 1.70 or more. If the refractive index is smaller than 1.60, it may be difficult to adjust the refractive index and to suppress the occurrence of interference fringes sufficiently.

Moreover, the content of the high refractive index epoxy monomer in the pattern alignment layer 12 is important, and is in range of 3.0 parts by mass and 8.0 parts by mass with respect to 100 parts by mass of the photo-alignment material included in the pattern alignment layer 12. Moreover, this content is preferably in the range of 3.0 parts by mass and 7.0 parts by mass, and more preferably approximately 5.0 parts by mass, with respect to 100 parts by mass of the photo-alignment material. If the content is smaller than 3.0 parts by mass, it is difficult to increase the refractive index of the pattern alignment layer 12 sufficiently and to effectively suppress the occurrence of interference fringes. On the other hand, if the content exceeds 8.0 parts by mass, it is undesirable because it may be difficult to effectively suppress interference fringes and deteriorate the alignment property.

### (Solvent)

A solvent used in the alignment layer composition is not particularly limited as long as the solvent can dissolve the photo-alignment material and the high refractive index epoxy monomer at a desired concentration. Examples of the solvent include hydrocarbon solvents such as benzene and hexane, ketone solvents such as methyl ethyl ketone, methyl isobutyl ketone, and cyclohexanone (CHN), ether solvents such as tetrahydrofuran, 1,2-dimethoxyethane, and propylene glycol monoethyl ether (PGME), alkyl halide solvents such as chloroform and dichloromethane, ester solvents such as methyl acetate, ethyl acetate, butyl acetate, and propylene glycol monomethyl ether acetate (PGMEA), amide solvents such as N,N-dimethylformamide, sulfoxide solvents such as dimethyl sulfoxide, anone solvents such as cyclohexane, alcohol solvents such as methanol, ethanol, and isopropyl alcohol (hereinafter referred to as “IPA”), and the like. However, the solvent is not limited to these examples. One type of the solvent may be used and a mixture of two or more types of the solvents may be used.

Moreover, the amount of the solvent is preferably between 600 and 3900 parts by mass with respect to 100 parts by mass of the photo-alignment material, for example. If the amount of the solvent is smaller than 600 parts by mass, it is undesirable because it may be difficult to dissolve the photo-alignment material uniformly. If the amount of the solvent exceeds 3900 parts by mass, it is undesirable because a portion of the solvent may remain, and the remaining solvent impregnates into the substrate 11 when the alignment layer composition is coated on the substrate 11, both a photo-alignment property and an adhesion to the substrate 11 may deteriorate.

### [Retardation Layer]

The retardation layer 13 contains a polymerizable liquid crystal composition. The polymerizable liquid crystal composition contains a liquid crystal compound (rod-shaped compound) that exhibits a crystalline property and has a polymerizable functional group in molecules.

### (Liquid Crystal Compound)

The liquid crystal compound has a refractive index anisotropy and has a function of providing a desired retardation property by being arranged regularly according to an alignment pattern. Examples of the liquid crystal compound include materials that exhibit a liquid crystal phase such as a nematic phase or a smectic phase. It is more preferable to use a liquid crystal compound that exhibits a nematic phase because the liquid crystal compound that exhibits the nematic phase is more easily arranged regularly than liquid crystal compounds that exhibit other liquid crystal phases.

As the nematic liquid crystal compound that exhibits the nematic phase, a material having spacers at both mesogenic ends is preferably used. Since the liquid crystal compound having spacers at both mesogenic ends has excellent flexibility, the retardation film 1 can have excellent transparency when such a liquid crystal compound is used.

The liquid crystal compound has a polymerizable functional group in molecules as described above. Due to the polymerizable functional group, the liquid crystal compound can be polymerized and fixed, the arrangement stability is excellent, and the retardation property rarely varies. More preferably, the liquid crystal compound has a three-dimensionally crosslinkable polymerizable functional group in molecules. Due to the three-dimensionally crosslinkable polymerizable functional group, the arrangement stability can be improved further. Herein, “three dimensional crosslink” means a state in which liquid crystalline molecules are polymerized three-dimensionally to create a mesh (network) structure.

Examples of the polymerizable functional group include a polymerizable functional group which polymerizes by the action of an ionizing radiation such as UV light or electron beams, or heat. Representative examples of these polymerizable functional groups include a radical polymerizable functional group, a cationic polymerizable functional group, and the like. Representative examples of the radical polymerizable functional group include a functional group having at least one addition-polymerizable ethylenically unsaturated double bond. Specific examples thereof include a vinyl group with or without a substituent, an acrylate group (a generic term of an acryloyl group, a methacryloyl group, an acryloyloxy group, and a methacryloyloxy group), and the like. In addition, specific examples of the cationic polymerizable functional group include an epoxy group and the like. Other examples of the polymerizable functional groups include an isocyanate group, an unsaturated triple bond, and the like. Among these polymerizable functional groups, a functional group having an ethylenically unsaturated double bond is ideally used because of advantages in process.

Particularly preferably, the liquid crystal compound has a polymerizable functional group at an end. By using such a liquid crystal compound, it is possible to polymerize the liquid crystal compound three-dimensionally to create a state of a mesh (network), for example. Thus, it is possible to form the patterned retardation film 1 having thermal stability and exhibiting an excellent optical property.

The amount of the liquid crystal compound is not particularly limited as long as the viscosity of a retardation layer forming coating solution (liquid crystal composition) can be adjusted to a desired value according to a method of coating the pattern alignment layer 12. However, the amount of the liquid crystal compound in a liquid crystal composition is preferably in the range of 5 parts by mass and 40 parts by mass, and more preferably in the range of 10 parts by mass and 30 parts by mass. If the amount of the liquid crystal compound is smaller than 5 parts by mass, it is undesirable because the amount of the liquid crystal compound is too small and thus it may be difficult to appropriately align light entering the retardation layer 13. On the other hand, if the amount of the liquid crystal compound exceeds 30 parts by mass, it is undesirable because the viscosity of the retardation layer forming coating solution becomes too high and thus the workability deteriorates.

Only one type of the liquid crystal compound may be used and two or more types of the liquid crystal compounds may be used. For example, when a mixture of a liquid crystal compound having one or more polymerizable functional groups at both ends and a liquid crystal compound having one or more polymerizable functional groups at one end is used as the liquid crystal compound, the polymerization density (crosslinking density) and the optical property can be arbitrary adjusted by adjusting the mixing ratio of the two liquid crystal compounds. Moreover, although it is preferable to use a liquid crystal compound having one or more polymerizable functional groups at both ends in order to secure reliability, it is preferable to use a liquid crystal compound having one polymerizable functional group at both ends in order to realize satisfactory liquid crystal alignment.

### (Solvent)

The liquid crystal compound is generally dissolved in a solvent. The solvent is not particularly limited as long as the solvent can disperse the liquid crystal compound uniformly. Examples of the solvent includes hydrocarbon solvents such as benzene and hexane, ketone solvents such as methyl ethyl ketone, methyl isobutyl ketone, and cyclohexanone (CHN), ether solvents such as tetrahydrofuran, 1,2-dimethoxyethane, and propylene glycol monoethyl ether (PGME), alkyl halide solvents such as chloroform and dichloromethane, ester solvents such as methyl acetate, ethyl acetate, butyl acetate, and propylene glycol monomethyl ether acetate (PGMEA), amide solvents such as N,N-dimethylformamide, sulfoxide solvents such as dimethyl sulfoxide, anone solvents such as cyclohexane, alcohol solvents such as methanol, ethanol, and isopropyl alcohol (hereinafter referred to as “IPA”), and the like. However, the solvent is not limited to these examples. One type of the solvent may be used and a mixture of two or more types of the solvents may be used.

The amount of the solvent is preferably between 66 parts by mass and 900 parts by mass with respect to 100 parts by mass of the liquid crystal compound. If the amount of the solvent is smaller than 66 parts by mass, it is undesirable because it may be difficult to dissolve the liquid crystal compound uniformly. On the other hand, if the amount of the solvent exceeds 900 parts by mass, it is undesirable because a portion of the solvent may remain, the reliability may decrease, and it may be difficult to coat uniformly.

### (Other Compounds)

The liquid crystal composition may contain other compounds as necessary. The other compounds are not particularly limited as long as the compounds do not disorder the arrangement of the liquid crystal compound. Examples thereof include a polymerization initiator, a polymerization inhibitor, a plasticizer, a surfactant, a silane coupling agent, and the like. For example, when a silicon-based high molecular weight leveling agent is added as a leveling agent, the content thereof is approximately 0.1% or more and smaller than 1%.

### (Thickness of Retardation Layer)

Although the thickness of the retardation layer 13 is not particularly limited, the thickness is preferably between 500 nm and 2000 nm in order to obtain an appropriate alignment performance.

### 1-2. Method for Manufacturing Retardation Film

Next, a method for manufacturing the patterned retardation film 1 will be described. In the following description, although a method for manufacturing the patterned retardation film 1 according to a photo-alignment method is described, the patterned retardation film 1 may be formed according to a UV molding method.

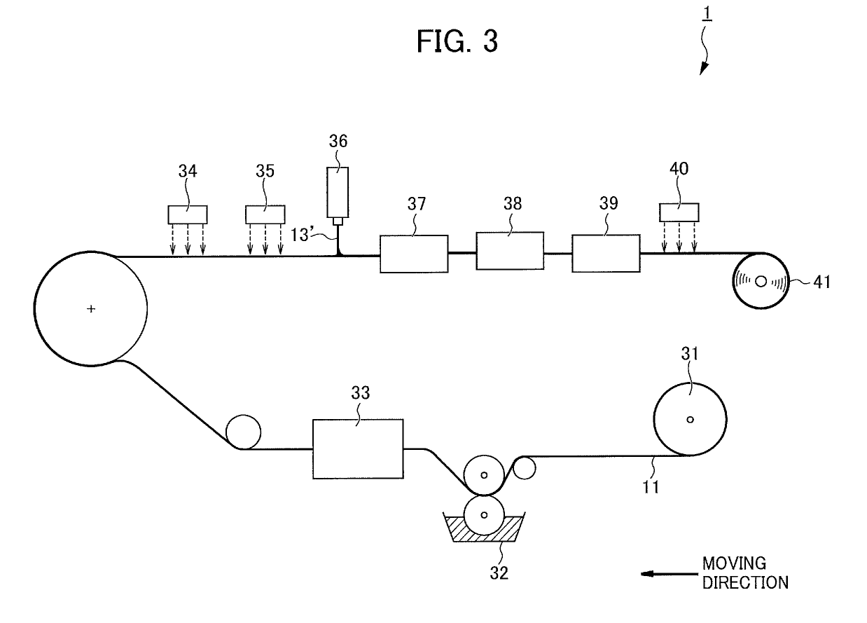

FIG. 3 is a diagram schematically illustrating the flow of the steps of manufacturing the patterned retardation film 1. (A) First, an alignment layer composition coating process of providing the substrate 11 from a long film wound around a roll 31 and coating the pattern alignment layer composition (alignment layer composition) 32 on the substrate 11 is performed. (B) Subsequently, a pattern alignment layer forming layer forming process of heat-curing the alignment layer composition using a drier 33 to form a thin film-shaped pattern alignment layer forming layer 12′ is performed. (C) Subsequently, a UV irradiation process of irradiating the pattern alignment layer forming layer 12′ with UV light from UV irradiation devices 34 and 35 is performed. With these processes (A) to (C), the pattern alignment layer 12 is formed.

(D) Subsequently, a retardation layer forming coating solution coating process of coating a retardation layer forming coating solution 13′ from a supply device 36 for supplying a retardation layer forming coating solution that contains a retardation layer forming polymerizable liquid crystal composition to form a retardation layer forming layer is performed. (E) Subsequently, a leveling process of leveling the thickness of the retardation layer forming layer using a leveling device 37 is performed. (F) After that, an alignment process of heating a liquid crystal compound contained in the coating film of the retardation layer forming coating solution 13′ to a liquid crystal phase forming temperature or higher using a drier 38 so that the liquid crystal compound is arranged along the different alignment directions of the first alignment region 12A corresponding to the right-eye region and the second alignment region 12B corresponding to the left-eye region, included in the pattern alignment layer 12 is performed. With this alignment process, the retardation layer forming layer becomes the retardation layer 13.

(G) After that, a cooling process of cooling a stacked structure including the substrate 11, the pattern alignment layer 12, and the retardation layer 13 using a cooler 39 is performed. (H) After that, the polymerizable liquid crystal compound is irradiated with UV light using a UV irradiation device 40. (I) A cutting process of winding the film around a reel 41 and cutting the film into a desired size is performed. With the above-described processes, the patterned retardation film 1 is manufactured.

### [(A) Alignment Layer Composition Coating Process]

First, an alignment layer composition coating process of providing the substrate 11 from a long film wound around the roll 31 to coat the pattern alignment layer composition 32 on the substrate 11 is performed.

### [Provision of Substrate]

A method of providing the substrate 11 is not particularly limited as long as a long film can be continuously transported, and a method which uses a general transporting unit may be used. Specifically, a method of using an unwinding machine that supplies a roll-shaped long film and a winding machine that winds the long film and a method of using a belt conveyor, a transporting roll, and the like may be used. In addition, a method of using a floating-type transporting carriage for transporting a long alignment layer forming film in a floated state by performing air ejection and suction may be used. Moreover, during transportation, the film is preferably transported with predetermined tension applied thereto, whereby the film can be continuously transported more stably.

The transporting unit preferably has a color that does not reflect UV light having passed through the long film when the transporting unit is disposed at a position in which the long film is irradiated with UV light. Specifically, the transporting unit is preferably black. The transporting unit can have the black color by treating the surface with chromium, for example.

The shape of the roll 31 is not particularly limited as long as the long film can be stably transported. When the roll 31 is disposed at the portion in which the long film is irradiated with the UV light, the roll 31 preferably has such a shape that a constant distance between the surface of the long film and the UV irradiation device can be maintained. The shape is generally preferably circular.

Here, by pulling the substrate 11 from the roll 31 and performing antiglare treatment (AG treatment), antireflection treatment (AR treatment), and the like sequentially on the substrate 11, it is possible to form an antiglare layer and an antireflection layer on the surface of the substrate 11.

### [Coating of Alignment Layer Composition 32]

As a method of coating the alignment layer composition 32, a die coating method, a gravure coating method, a reverse coating method, a knife coating method, a dip coating method, a spray coating method, an air knife coating method, a spin coating method, a roll coating method, a printing method, an immersion and lifting method, a curtain coating method, a casting method, a bar coating method, an extrusion coating method, an E-type coating method, and the like may be used. By coating the alignment layer composition 32 on the substrate 11 according to these coating methods, the pattern alignment layer forming layer 12′ is formed.

The thickness of the pattern alignment layer forming layer 12′ is not particularly limited as long as the thickness is within the range where desired flatness is obtained. The thickness is preferably in the range of 0.1 μm and 10 μm, and more preferably in the range of 0.1 μm and 5 μm, and further preferably in the range of 0.1 μm and 3 μm.

Here, in the present embodiment, a composition that contains an epoxy monomer having a refractive index of 1.60 or higher in a content range of 3.0 parts by mass and 8.0 parts by mass with respect to 100 parts by mass of a photo-alignment material is used as the alignment layer composition 32 together with the photo-alignment material. When such an alignment layer composition 32 is coated on the substrate 11 to form the pattern alignment layer 12, it is possible to increase the refractive index of the pattern alignment layer 12 with the aid of the epoxy monomer added to the pattern alignment layer 12 and to effectively suppress the occurrence of interference fringes due to a difference in refractive index from that of the retardation layer 13 formed on the pattern alignment layer 12.

### [(B) Pattern Alignment Layer Forming Layer Forming Process]

In the pattern alignment layer forming layer forming process, the alignment layer composition 32 coated on the substrate 11 is heat-cured using the drier 33. In this process, the substrate 11 coated with the alignment layer composition 32 is guided to the drier 33 to heat-cure the alignment layer composition 32 and is delivered to the next step in a half-dried state.

The curing temperature of the alignment layer composition 32 is preferably between 100° C. and 130° C. If the curing temperature is lower than 100° C., it is undesirable because the alignment layer composition 32 may not be heat-cured uniformly and the thin film may not be uniform. On the other hand, if the curing temperature exceeds 130° C., it is undesirable because the substrate 11 or the thin film may be contracted.

Moreover, the curing period of the alignment layer composition 32 is preferably 1 minutes or longer and shorter than 10 minutes. If the curing period is shorter than 1 minutes, it is undesirable because heat-curing may not be realized and the thin film may not be uniform. On the other hand, if the curing period is longer than 10 minutes, it is undesirable because contaminations or defects may occur and the substrate 11 or the thin film may be contracted.

### [(C) UV Irradiation Process]

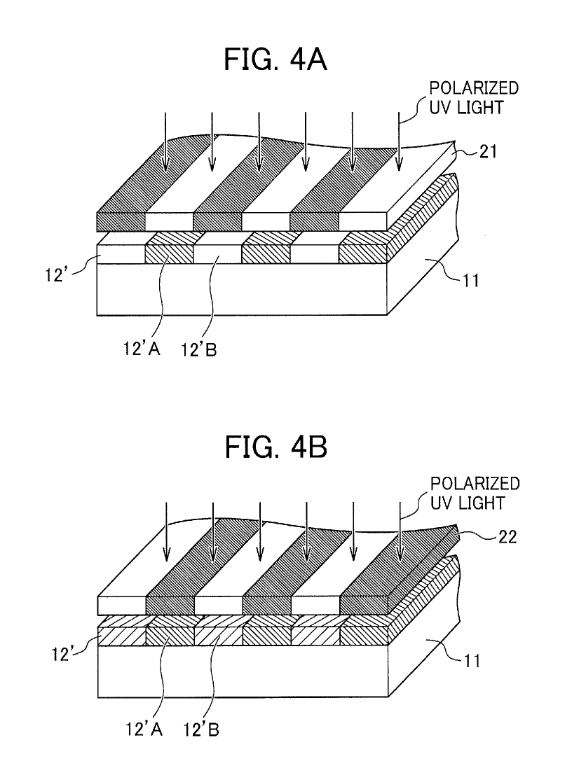

Subsequently, a UV irradiation process of irradiating the pattern alignment layer forming layer 12′ with UV light is performed. In the UV irradiation process, first, as illustrated in FIG. 4A, the pattern alignment layer forming layer 12′ is irradiated with linearly polarized UV light (polarized UV light) using a mask 21 in which a first alignment preparation region 12′A corresponding to the right-eye region is not blocked and a second alignment preparation region 12′B corresponding to the left-eye region is blocked, whereby the first alignment preparation region 12′A that is not blocked is aligned in a desired direction. Subsequently, as illustrated in FIG. 4B, the pattern alignment layer forming layer 12′ is irradiated with linearly polarized UV light of which the polarization direction is different by 90° from that of the first irradiation using a mask 22 in which the first alignment preparation region 12′A is blocked and the second alignment preparation region 12′B is not blocked, whereby the second alignment preparation region 12′B that is not blocked is aligned in a desired direction. By the two rounds of UV irradiation, two types of alignment patterns are formed.

In the example of FIGS. 4A and 4B, the first alignment preparation region 12′A is first irradiated with polarized UV light and then the second alignment preparation region 12′B is irradiated with polarized UV light. However, UV irradiation is not limited to this order, and the second alignment preparation region 12′B may be first irradiated with polarized UV light and then the first alignment preparation region 12′A may be irradiated with polarized UV light. Moreover, in FIGS. 4A and 4B, although the masks 21 and 22 are used in both the first and second rounds of irradiation, the mask 21 may be used during the first round of irradiation and the mask 22 may not be used in the second round of irradiation.

The mask pattern (that is, the pattern of the patterned irradiation) is not particularly limited as long as the first alignment region 12A (see FIG. 2) corresponding to the right-eye region and the second alignment region 12B (see FIG. 2) corresponding to the left-eye region can be formed stably. Examples of the mask pattern include a stripe-shaped pattern, a mosaic pattern, a staggered pattern, and the like. Among these pattern shapes, a stripe-shaped pattern is preferable, and particularly, a stripe-shaped pattern having stripes parallel to each other in the longitudinal direction of the long film is preferable. That is, the patterned irradiation preferably involves irradiating a stripe-shaped pattern having stripes parallel to each other in the longitudinal direction of the long film with polarized UV light.

The pattern widths of the mask, that is, irradiation widths and intervals (non-irradiation widths) of polarized UV light may be equal or different. However, the width of the region corresponding to the right-eye region and the width of the region corresponding to the left-eye region are preferably equal to each other. Moreover, when the mask pattern is aligned with the stripe lines of a color filter, light is irradiated in such a width that the pattern in which the region corresponding to the right-eye region and the region corresponding to the left-eye region are formed corresponds to the stripe pattern of the color filter.

For example, for use in three-dimensional display, the pattern width is preferably in the range of 50 μm and 1000 μm and more preferably in the range of 100 μm and 800 μm. The pattern width referred herein means the pattern width of the pattern alignment layer 12 when the substrate 11 is stably contracted.

A material that forms the mask is not particularly limited as long as the material can form a desired opening. Examples thereof include metal, quartz, and the like which rarely deteriorate with UV light. Specifically, a material obtained by patterning a metal substrate such as SUS through etching, laser machining, or electroforming, and if necessary, applying surface treatment such as nickel plating may be used. In addition, a material having emulsion (silver salt) or a light blocking film formed of chromium on a substrate formed of soda lime glass or quartz may be used.

Among these materials, a material obtained by patterning synthetic quartz with Cr is preferable. By doing so, the pattern alignment layer forming layer 12′ having excellent dimensional stability against a temperature change, a humidity change, or the like and excellent UV transmittance and formed of a cured material of the pattern alignment layer composition can be irradiated with UV light with high accuracy. As a result, it is possible to form the pattern alignment layer 12 with high accuracy.

The thickness of the synthetic quartz mask is not particularly limited as long as the pattern can be formed with high dimensional accuracy. The thickness is preferably in the range of 1 mm and 20 mm, and more preferably in the range of 5 mm and 18 mm, and further preferably in the range of 9 mm and 16 mm. When the thickness is in the above-mentioned range, it is possible to prevent flexure and to provide high dimensional accuracy. Moreover, the thickness in the above-mentioned range is preferred since it is easy to handle a photomask.

The polarization direction of the polarized UV light is not particularly limited as long as the polarization direction in the region corresponding to the right-eye region is different from the polarization direction in the region corresponding to the left-eye region. The difference between the two polarization directions is preferably 90°. By doing so, the directions (slow axis directions) in which the refractive index is maximized in a first retardation region 13A and a second retardation region 13B can be made orthogonal to each other, and a display device capable of displaying images three-dimensionally can be formed more appropriately.

The directions of which the difference is 90° are not particularly limited as long as a display device capable of displaying images three-dimensionally can display images three-dimensionally with high accuracy when the display device is formed using a retardation film obtained by cutting the long patterned retardation film 1. In general, the directional difference is preferably in the range of 90°±3°, and more preferably, in the range of approximately 90°±2°, and further preferably, in the range of approximately 90°±1°.

The polarized UV light may be condensed or may not be condensed. When the pattern irradiation is performed on a long film on the transporting roll (that is, when there is a difference in distance from a polarized UV light source in the region irradiated with the polarized UV light), light is preferably condensed in the transporting direction. By doing so, the influence of the distance from the light source can be reduced and the alignment region can be formed with high pattern accuracy.

The wavelength of the polarized UV light is appropriately set according to a photo-alignment material or the like. The wavelength may be set to a wavelength used for allowing a general photo-alignment material to exhibit an alignment regulation force. Specifically, the wavelength of the irradiation light is in the range of 210 nm and 380 nm, and preferably in the range of 230 nm and 380 nm, and more preferably in the range of 250 nm and 380 nm.

If a method of generating the polarized UV light is not particularly limited as long as the method can stably irradiate polarized UV light. For example, a method of irradiating UV light through a polarizer capable of transmitting only the light which is polarized in a certain direction may be used. A polarizer which is generally used for generating polarized light may be used as such a polarizer. For example, a wire grid polarizer having a slit-shaped opening, a method of stacking a plurality of quartz plates and separating polarized light by the Brewster angle, a method of separating polarized light using the Brewster angle of deposited multilayer films having different refractive indexes, and the like may be used.

The irradiation amount (accumulated amount) of the polarized UV light is not particularly limited as long as an alignment region having a desired alignment regulation force can be formed. For example, when the wavelength is 310 nm, the irradiation amount is preferably in the range of 5 mJ/cm² and 500 mJ/cm², more preferably in the range of 7 mJ/cm² and 300 mJ/cm², and further preferably in the range of 10 mJ/cm² and 100 mJ/cm². With such an irradiation amount, it is possible to form an alignment region having a sufficient alignment regulation force.

It is preferable that the temperature of a thin film is regulated to be constant when the thin film is irradiated with the polarized UV light. This is because it is possible to form the alignment region with high accuracy. The temperature of the thin film is preferably in the range of 15° C. and 90° C., and more preferably in the range of 15° C. and 60° C. As a temperature regulating method, a method of using a temperature regulating device such as a general heating and cooling device may be used.

### [(D) Retardation Layer Forming Coating Solution Coating Process]

Subsequently, in the retardation layer forming coating solution coating process, a retardation layer forming coating solution is coated on the formed pattern alignment layer 12 from the device 36 for supplying the retardation layer forming coating solution. A coating method is not particularly limited as long as the method can stably apply a coating film formed of the retardation layer forming coating solution to the pattern alignment layer 12, and the method described in the alignment layer coating process (A) can be used.

The retardation layer 13 contains a liquid crystal compound and exhibits a retardation property. The degree of a retardation property is determined depending on the type of the liquid crystal compound and the thickness of the retardation layer 13. Thus, the thickness of the retardation layer forming layer is not particularly limited as long as a predetermined retardation property can be attained, and the thickness can be appropriately determined according to the use or the like of the patterned retardation film 1.

### [(E) Leveling Process]

Subsequently, a leveling process of leveling the thickness of the retardation layer forming layer using the leveling device 37 is performed. Preferably, the retardation layer forming coating solution is applied to the retardation layer forming layer so that the thickness within such a range that an in-plane retardation of the retardation layer 13 formed thereafter corresponds to λ/4. By doing so, the linearly polarized beam that passes through the first retardation region 13A and the second retardation region 13B can be converted to circularly polarized beams that are orthogonal to each other. As a result, it is possible to display a three-dimensional video with high accuracy.

When the distance is set to such a range that the in-plane retardation of the retardation layer 13 corresponds to λ/4, the specific distance is determined appropriately according to the type of the liquid crystal compound. When a general liquid crystal compound is used, although the distance is in the range of 0.5 μm and 2 μm, the distance is not limited to this.

### [(F) Alignment Process]

Subsequently, the liquid crystal compound contained in the coating film of the retardation layer forming coating solution is arranged along the different alignment directions of the first and second alignment regions 12A and 12B included in the pattern alignment layer 12. A method of arranging the liquid crystal compound is not particularly limited as long as the method can arrange the liquid crystal compound in a desired direction. For example, a method of heating the liquid crystal compound to a liquid crystal phase forming temperature or higher using the drier 38 may be used.

The pattern of the retardation layer 13 formed by this alignment process becomes the same as the pattern of the pattern alignment layer 12. Thus, the first retardation region 13A corresponding to the right-eye region is formed on the first alignment region 12A corresponding to the right-eye region, and the second retardation region 13B corresponding to the left-eye region is formed on the second alignment region 12B corresponding to the left-eye region.

### [(G) Cooling Process]

After that, a cooling process of cooling the stacked structure including the substrate 11, the pattern alignment layer 12, and the retardation layer 13 using the cooler 39 is performed. This cooling process may be performed until the temperature of the stacked structure reaches approximately the room temperature, for example.

### [(H) Curing Process]

Subsequently, a curing process of polymerizing and curing the polymerizable liquid crystal compound is performed. Although a method of polymerizing the polymerizable liquid crystal compound may be determined arbitrarily according to the type of the polymerizable functional group included in the polymerizable liquid crystal compound, a method of curing the polymerizable liquid crystal compound by irradiation of actinic radiation with an appropriate amount of added polymerization initiator is preferred. The actinic radiation is not particularly limited as long as the radiation can polymerize the polymerizable liquid crystal compound. In general, UV light or visible light is preferably used from the perspective of availability of the device. Specifically, the same UV light as used when forming the pattern alignment layer 12 may be used. With the curing process, the liquid crystal compounds are polymerized with each other since to create a mesh (network) structure. Thus, it is possible to form the retardation layer 13 having thermal stability and exhibiting an excellent optical property.

### [(I) Manufacturing of Patterned Retardation Film 1]

Subsequently, the film is wound around the reel 41. After that, the film is cut into a desired size. With the above-described processes, the patterned retardation film 1 is manufactured.

### EXAMPLES

Hereinafter, the present invention will be described in further detail with reference to examples. However, the present invention is not limited to the following examples.

### Example 1-1

A 40 μm-thick acrylic film (refractive index: 1.48) of which the front surface has been subjected to antiglare treatment was used as a substrate. An alignment layer composition having a sold content of 5% was applied to the rear surface of the acrylic film according to a die coating method so that the thickness of the acrylic film after curing becomes 200 nm. The alignment layer composition was obtained by dissolving 100 parts by mass of a photo-alignment material having a polyvinylcinnamate (PVCi) group and 3.0 parts by mass of an epoxy monomer having a refractive index of 1.70 (a bifunctional epoxy monomer having a fluorene skeleton, product name: OGSOL CG-500, formed by Osaka Gas Chemicals Co., Ltd.) in a mixed solvent that contains isobutyl acetate. The substrate was dried for 2 minutes in a drier regulated to 100° C. to evaporate the solvent and heat-cure the compositions to form a photo-alignment layer (refractive index: 1.57).

Subsequently, the photo-alignment layer was irradiated with polarized UV light having an accumulated irradiation amount of 40 mJ/cm² in a pattern having an interval of approximately 500 μm in a direction parallel to the transporting direction of a master film to form a pattern alignment layer having a thickness of 200 nm. The polarized UV light had a polarization axis inclined by an angle of ±45° with respect to the transporting direction of the film.

Subsequently, a liquid crystal composition of photo-polymerizable nematic liquid crystals (solid content: 30%, using MIBK as a solvent) was applied to the formed pattern alignment layer according to a die coating method and was dried. After that, the liquid crystal composition was polymerized with irradiation of UV light to form a retardation layer (refractive index: 1.60) having a thickness of 1 μm, and a retardation film was obtained.

### Example 1-2

A retardation film was obtained similarly to Example 1-1 except that the same epoxy monomer as Example 1-1 was contained in a proportion of 5.0 parts by mass with respect to 100 parts by mass of the photo-alignment material.

### Example 1-3

A retardation film was obtained similarly to Example 1-1 except that the same epoxy monomer as Example 1-1 was contained in a proportion of 7.0 parts by mass with respect to 100 parts by mass of the photo-alignment material.

### Comparative Example 1-1

A retardation film was obtained similarly to Example 1-1 except that 5.0 parts by mass of a high refractive index resin (product name: HIC-GL, formed by Kyoeisha Chemical Co., Ltd.) having a refractive index of 1.61 was contained with respect to 100 parts by mass of the photo-alignment material.

### Comparative Example 1-2

A retardation film was obtained similarly to Example 1-1 except that 7.0 parts by mass of a high refractive index resin (product name: HIC-GL, formed by Kyoeisha Chemical Co., Ltd.) having a refractive index of 1.61 was contained with respect to 100 parts by mass of the photo-alignment material.

### Comparative Example 1-3

A retardation film was obtained similarly to Example 1-1 except that 3.0 parts by mass of an inorganic particle-containing resin (product name: ASR-179S50, formed by Kyoeisha Chemical Co., Ltd.) having a refractive index of 1.79 was contained with respect to 100 parts by mass of the photo-alignment material.

### Comparative Example 1-4

A retardation film was obtained similarly to Example 1-1 except that 3.0 parts by mass of epoxy ester (product name: M-600A, formed by Kyoeisha Chemical Co., Ltd.) having a refractive index of 1.53 was contained with respect to 100 parts by mass of the photo-alignment material.

### Comparative Example 1-5

A retardation film was obtained similarly to Example 1-1 except that 5.0 parts by mass of epoxy ester (product name: M-600A, formed by Kyoeisha Chemical Co., Ltd.) having a refractive index of 1.53 was contained with respect to 100 parts by mass of the photo-alignment material.

### Comparative Example 1-6

A retardation film was obtained similarly to Example 1-1 except that 5.0 parts by mass of acrylate (product name: EA-0200, formed by Osaka Gas Chemicals Co., Ltd.) having a refractive index of 1.62 was contained with respect to 100 parts by mass of the photo-alignment material.

### Comparative Example 1-7

A retardation film was obtained similarly to Example 1-1 except that 5.0 parts by mass of PETA (product name: PET-30, formed by Nippon Kayaku Co., Ltd.) having a refractive index of 1.48 was contained with respect to 100 parts by mass of the photo-alignment material.

### Comparative Example 1-8

A retardation film was obtained similarly to Example 1-1 except that 5.0 parts by mass of DPHA (product name: A-DPH, formed by Shin-Nakamura Chemical Co., Ltd.) having a refractive index of 1.49 was contained with respect to 100 parts by mass of the photo-alignment material.

### Comparative Example 1-9

A retardation film was obtained similarly to Example 1-1 except that 5.0 parts by mass of acrylic polymer (product name: Vanaresin GH-1203, formed by Shin-Nakamura Chemical Co., Ltd.) having a refractive index of 1.49 was contained with respect to 100 parts by mass of the photo-alignment material.

### Comparative Example 1-10

A retardation film was obtained similarly to Example 1-1 except that the same epoxy monomer as Example 1-1 was contained in a proportion of 2.0 parts by mass with respect to 100 parts by mass of the photo-alignment material.

### Comparative Example 1-11

A retardation film was obtained similarly to Example 1-1 except that the same epoxy monomer as Example 1-1 was contained in a proportion of 9.0 parts by mass with respect to 100 parts by mass of the photo-alignment material.

### Evaluation

The degree of occurrence of interference fringes and an alignment property were evaluated for the retardation films obtained in Examples and Comparative Examples.

A side of the retardation film close to the retardation layer was bonded to a black acrylic board and interference fringes were visually evaluated (appearance evaluation) from the substrate side under a fluorescent light. A mark “⊚” was assigned to those in which the occurrence of interference fringes were suppressed remarkably, a mark “◯” was assigned to those in which the occurrence of interference fringes were suppressed slightly, a mark “Δ” was assigned to those in which there was a few improvement in suppressing the occurrence of interference fringes, and a mark “X” was assigned to those in which there was no improvement in suppressing the occurrence of interference fringes. Further, those assigned with the marks “⊚” and “◯” were evaluated as satisfactory and those assigned with the marks “Δ” and “X” were evaluated as poor. A mark “−” indicates that it was not possible to evaluate the occurrence of interference fringes.

The alignment property was evaluated based on an in-plane variation in the optical axis in a very small region when the optical axis was measured at 9 measurement sample points using a retardation measurement device (product name: Axostep, formed by Axometrics, Inc.). The variation in the optical axis was defined by the standard deviation (σ) of the optical axis of the measured samples. A mark “⊚” was assigned to those having the σ value (unit: °) smaller than 1.0, a mark “◯” was assigned to those having the σ value of 1.0 or more and smaller than 1.5, a mark “Δ” was assigned to those having the σ value of 1.5 or more and smaller than 2.0, and a mark “X” was assigned to those having the σ value of 2.0 or larger. Further, those assigned with the marks “⊚” and “◯” were evaluated as having a satisfactory alignment property and those assigned with the marks “Δ” and “X” were evaluated as having a poor alignment property.

Table 1 illustrates the compounds added to the pattern alignment layer and the added amounts thereof (the proportion to 100 parts by mass of the photo-alignment material) and the evaluation results on the occurrence of interference fringes and an alignment property of the retardation film.

TABLE 1

| | | | Refractive | Added Amount | Interference | Alignment |
|---|---|---|---|---|---|---|
| | Added Material | Product Name | Index | (Parts by mass) | Fringes | Property |
| Example 1-1 | Epoxy Monomer | OGSOL CG-500 | 1.70 | 3.0 | ◯ | ⊚ |
| Example 1-2 | (Bifunctional Epoxy | (Osaka Gas Chemical) | | 5.0 | ⊚ | ⊚ |
| Example 1-3 | having Fluorene Skeleton) | | | 7.0 | ⊚ | ◯ |
| Comparative | High Refractive | HIC-GL | 1.61 | 5.0 | Δ | ◯ |
| Example 1-1 | Index Resin | (Kyoeisha Chemical) | | | | |
| Comparative | High Refractive | HIC-GL | 1.61 | 7.0 | ◯ | Δ |
| Example 1-2 | Index Resin | (Kyoeisha Chemical) | | | | |
| Comparative | Inorganic Particle - | ASR-179S50 | 1.79 | 3.0 | — | X |
| Example 1-3 | Containing Resin | (Kyoeisha Chemical) | | | | |
| Comparative | Epoxy Ester | M-600A | 1.53 | 3.0 | X | ⊚ |
| Example 1-4 | | (Kyoeisha Chemical) | | | | |
| Comparative | Epoxy Ester | M-600A | 1.53 | 5.0 | Δ | ⊚ |
| Example 1-5 | | (Kyoeisha Chemical) | | | | |
| Comparative | Acrylate | EA-0200 | 1.62 | 5.0 | ◯ | Δ |
| Example 1-6 | | (Osaka Gas Chemical) | | | | |
| Comparative | PETA | PET-30 | 1.48 | 5.0 | X | ⊚ |
| Example 1-7 | | (Nippon Kayaku) | | | | |
| Comparative | DPHA | A-DPH | 1.49 | 5.0 | X | ⊚ |
| Example 1-8 | | (Shin-Nakamura Chemical) | | | | |
| Comparative | Acrylic Polymer | Vanaresin GH-1203 | 1.49 | 5.0 | — | X |
| Example 1-9 | | (Shin-Nakamura Chemical) | | | | |
| Comparative | Epoxy Monomer | OGSOL CG-500 | 1.70 | 2.0 | Δ | ⊚ |
| Example 1-10 | (Bifunctional Epoxy | (Osaka Gas Chemical) | | | | |
| Comparative | having Fluorene Skeleton) | | | 9.0 | ⊚ | Δ |
| Example 1-11 | | | | | | |

As illustrated in the results of Examples in Table 1, in the retardation films of Examples 1-1 to 1-3 in which an epoxy monomer was contained in the pattern alignment layer, the occurrence of interference fringes were effectively suppressed and the alignment property was satisfactory.

On the other hand, in Comparative Examples 1-1 to 1-6 in which a high refractive index resin (refractive index: 1.61), an inorganic particle-containing resin (refractive index: 1.79), an epoxy ester (refractive index: 1.53), and acrylate (refractive index: 1.62) were contained in the retardation layer instead of the epoxy monomer, the effect of suppressing the occurrence of interference fringes were observed but the alignment property deteriorated in Comparative Example 1-2 in which 7.0 parts by mass of the high refractive index resin was contained and Comparative Example 1-6 in which 5.0 parts by mass of acrylate was contained, for example. In the other comparative examples, it was not possible to effectively suppress the occurrence of interference fringes.

Moreover, it can be understood that, even when a high refractive index epoxy monomer was contained in the pattern alignment layer, if the content is 2.0 parts by mass (Comparative Example 1-10), the effect of suppressing the occurrence of interference fringes were small. Moreover, it can be understood that, if the content is 9.0 parts by mass (Comparative Example 1-11), the effect of suppressing the occurrence of interference fringes were sufficiently high but the alignment property deteriorated.

### Second Embodiment

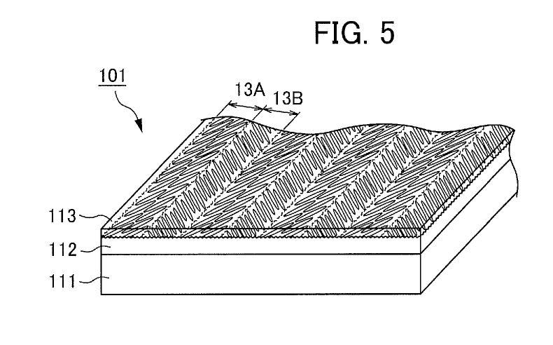

FIG. 5 is a diagram illustrating an example of a patterned retardation film 101 according to a second embodiment of the present invention. In this embodiment, the patterned retardation film 101 forms an image display device and a 3D image display system. The patterned retardation film 101 includes a substrate 111, a pattern alignment layer 12 which is an alignment layer having an alignment pattern, and a retardation layer 13 that contains a liquid crystal compound. In the patterned retardation film 101, the retardation layer 113 contains an alkoxysilane in a predetermined proportion.

### [Substrate]

The substrate 111 has the same configuration as the substrate 11 related to the patterned retardation film described in the first embodiment.

### [Pattern Alignment Layer]

The pattern alignment layer 112 has the same configuration as the pattern alignment layer 12 described in the first embodiment except that the pattern alignment layer 112 does not contain the high refractive index epoxy monomer described in the first embodiment. The pattern alignment layer 112 may contain a high refractive index epoxy monomer.

### [Retardation Layer]

The retardation layer 113 has the same configuration as the retardation layer 13 described in the first embodiment except that the retardation layer 113 contains alkoxysilane in a predetermined proportion.

### (Low Refractive Index Material)

Here, the refractive indices of the respective layers will be discussed. In general, the refractive index of the substrate is approximately 1.48 when a TAC substrate is used as the substrate, for example, and the refractive index of an alignment film that forms the pattern alignment layer is approximately 1.54. On the other hand, the refractive index of polymerizable liquid crystals is approximately between 1.55 and 1.75, which is higher than the refractive index of the substrate and the pattern alignment layer. Thus, due to a difference in refractive index between the substrate or the pattern alignment film and the retardation layer, an unevenness may occur based on thin film interference between the retardation layer and the substrate and interference fringes may occur.

Thus, in the patterned retardation film 101 according to the present embodiment, the retardation layer 113 contains a low refractive index material (specifically, alkoxysilane having a molecular weight of 300 or smaller) in a predetermined proportion. Such a retardation layer 113 can be obtained by including alkoxysilane in a predetermined proportion in a polymerizable liquid crystal composition together with a liquid crystal compound and coating the pattern alignment layer 12 using the liquid crystal composition.

In the patterned retardation film 101, since the retardation layer 113 contains alkoxysilane in a predetermined proportion, it is possible to effectively decrease the refractive index of the retardation layer 113 and to suppress the occurrence of interference fringes due to a difference in refractive index between the films. It is considered that the alkoxysilane forms a certain distribution in the retardation layer 113 to thereby effectively decrease the refractive index of the retardation layer 113. According to such a patterned retardation film 101, it is possible to effectively suppress interference fringes without narrowing the width of choice of the materials that form the substrate 111, the pattern alignment layer 12, and the retardation layer 113.

Further, according to such alkoxysilane, even when the alkoxysilane is added to the retardation layer 113, it is possible to effectively suppress interference fringes while maintaining a satisfactory alignment property without affecting the alignment property of the liquid crystal compound. Specifically, the patterned retardation film 101 is a retardation film which maintains a satisfactory alignment property in which the standard deviation (σ) of an in-plane variation in an optical axis in a very small region when the optical axis was measured is smaller than 1.5. A variation in the optical axis can be defined by a standard deviation (σ) (unit: °) of the optical axis.

Here, the alkoxysilane is a compound having an aryl group such as an alkyl group or a phenyl group as its functional group together with an alkoxy group and examples thereof include an alkoxysilane in which the ends of these functional groups are halogenated by fluorine or the like. Specifically, although the alkoxysilane is not particularly limited, examples thereof include methyltrimethoxysilane, methyltriethoxysilane, ethyltrimethoxysilane, propyltrimethoxysilane, butyltrimethoxysilane, hexyltrimethoxysilane, decyltrimethoxysilane, dodecyltrimethoxysilane, trifluoropropyltrimethoxysilane, phenyltriethoxysilane, and the like.

An ideal range of the refractive indices of the alkoxysilane is different depending on the type of the substrate or the pattern alignment layer used, and the refractive index is preferably 1.50 or smaller, and more preferably, 1.48 or smaller. If the refractive index exceeds 1.50, it may be difficult to adjust the refractive index and to suppress the occurrence of interference fringes sufficiently. For example, when a TAC substrate is used as the substrate 111, since the refractive index of the TAC substrate is approximately 1.48, it is preferable to use an alkoxysilane having a refractive index of 1.48 or smaller. The lower limit of the refractive index of the alkoxysilane not particularly limited. However, since it is difficult to obtain an alkoxysilane having a low refractive index, the refractive index may be set to approximately 1.30 or more.

Moreover, the content of the alkoxysilane in the retardation layer 113 is important, and is in the range of 2.0 parts by mass and 14.0 parts by mass with respect to 100 parts by mass of the liquid crystal compound included in the retardation layer 113. Moreover, the content is preferably between 3.0 parts by mass and 7.0 parts by mass, and more preferably approximately 5.0 parts by mass with respect to 100 parts by mass of the liquid crystal compound. If the content is smaller than 2.0 parts by mass, it is difficult to decrease the refractive index of the retardation layer 113 sufficiently and to effectively suppress the occurrence of interference fringes. On the other hand, if the content exceeds 14.0 parts by mass, it is undesirable because it may be difficult to effectively suppress interference fringes and deteriorate the alignment property.

### (Solvent)

The alkoxysilane which is a low refractive index material is generally dissolved in a solvent. The solvent is not particularly limited as long as the solvent can disperse the liquid crystal compound and the like uniformly, and various solvents described in the first embodiment can be used.

The amount of the solvent is preferably between 66 parts by mass and 900 parts by mass with respect to 100 parts by mass of the liquid crystal compound. If the amount of the solvent is smaller than 66 parts by mass, it is undesirable because it may be difficult to dissolve the liquid crystal compound uniformly. On the other hand, if the amount of the solvent exceeds 900 parts by mass, it is undesirable because a portion of the solvent may remain, the reliability may decrease, and it may be difficult to coat uniformly.

### 2. Method for Manufacturing Retardation Film

The patterned retardation film 101 can be formed similarly to the patterned retardation film 1 described in the first embodiment.

In the present embodiment, a composition that contains an alkoxysilane in a content range of 2.0 parts by mass and 14.0 parts by mass with respect to 100 parts by mass of the liquid crystal compound is used as a retardation layer forming coating solution (that is, a liquid crystal composition) together with a liquid crystal compound. When such a liquid crystal composition is coated on the pattern alignment layer 12 to form the retardation layer 113, it is possible to decrease the refractive index of the retardation layer 113 with the aid of the alkoxysilane added to the retardation layer 113 and to effectively suppress the occurrence of interference fringes due to a difference in refractive index between films.

### Example 2-1

A 60 μm-thick TAC film (refractive index: 1.48) of which the front surface has been subjected to antiglare treatment was used as a substrate. A photo-alignment film composition (using an isobutyl acetate as a solvent) that contains a photo-alignment material having a polyvinylcinnamate (PVCi) group was applied to the rear surface of the TAC film according to a die coating method so that the thickness of the TAC film after curing becomes 200 nm. The substrate was dried for 2 minutes in a drier regulated to 100° C. to evaporate the solvent and heat-cure the compositions to form an alignment layer (refractive index: 1.56).

Subsequently, the alignment layer was irradiated with polarized UV light having an accumulated irradiation amount of 40 mJ/cm² in a pattern having an interval of approximately 500 μm in a direction parallel to the transporting direction of a master film to form a pattern alignment layer having a thickness of 200 nm. The polarized UV light had a polarization axis inclined by an angle of ±45° with respect to the transporting direction of the film.

Subsequently, a liquid crystal composition (using MIBK as a diluting solvent) of photo-polymerizable nematic liquid crystals (refractive index of polymerizable liquid crystals only: 1.62, product name: licrivue (registered trademark) RMS03-013C, formed by Merck Corporation) that contain 5.0 parts by mass of alkoxysilane(methyltrimethoxysilane) (product name: KBM13, formed by Sin-Etsu Chemical Co., Ltd.) having a refractive index of 1.37 and a molecular weight of 136.9 with respect to 100 parts by mass of the liquid crystal compound was applied to the formed pattern alignment layer according to a die coating method and was dried. After that, the liquid crystal composition was polymerized with irradiation of UV light to form a retardation layer having a thickness of 1 μm, and a retardation film was obtained.

### Example 2-2

A retardation film was obtained similarly to Example 2-1 except that 5.0 parts by mass of an alkoxysilane (decyltrimethoxysilane) (product name: KBM3103, formed by Shin-Etsu Chemical Co., Ltd.) having a refractive index of 1.42 and a molecular weight of 262.5 was contained with respect to 100 parts by mass of the liquid crystal compound.

### Example 2-3

A retardation film was obtained similarly to Example 2-1 except that 5.0 parts by mass of an alkoxysilane (trifluoropropyltrimethoxysilane) (product name: KBM7103, formed by Shin-Etsu Chemical Co., Ltd.) having a refractive index of 1.35 and a molecular weight of 218.2 was contained with respect to 100 parts by mass of the liquid crystal compound.

### Example 2-4

A retardation film was obtained similarly to Example 2-1 except that 3.0 parts by mass of an alkoxysilane (decyltrimethoxysilane) (product name: KBM3103, formed by Shin-Etsu Chemical Co., Ltd.) having a refractive index of 1.42 and a molecular weight of 262.5 was contained with respect to 100 parts by mass of the liquid crystal compound.

### Example 2-5

A retardation film was obtained similarly to Example 2-1 except that 7.0 parts by mass of an alkoxysilane (decyltrimethoxysilane) (product name: KBM3103, formed by Shin-Etsu Chemical Co., Ltd.) having a refractive index of 1.42 and a molecular weight of 262.5 was contained with respect to 100 parts by mass of the liquid crystal compound.

### Example 2-6

A retardation film was obtained similarly to Example 2-1 except that 10.0 parts by mass of an alkoxysilane (decyltrimethoxysilane) (product name: KBM3103, formed by Shin-Etsu Chemical Co., Ltd.) having a refractive index of 1.42 and a molecular weight of 262.5 was contained with respect to 100 parts by mass of the liquid crystal compound.

### Comparative Example 2-1

A retardation film was obtained similarly to Example 2-1 except that 5.0 parts by mass of an acrylic monomer (product name: LINC-162A, formed by Kyoeisha Chemical Co., Ltd.) having a refractive index of 1.39 and a molecular weight of 570.3 was contained with respect to 100 parts by mass of the liquid crystal compound.

### Comparative Example 2-2

A retardation film was obtained similarly to Example 2-1 except that 5.0 parts by mass of an acrylic monomer (product name: Light Ester M-3F, formed by Kyoeisha Chemical Co., Ltd.) having a refractive index of 1.45 and a molecular weight of 114.1 was contained with respect to 100 parts by mass of the liquid crystal compound.

### Comparative Example 2-3

A retardation film was obtained similarly to Example 2-1 except that 5.0 parts by mass of an silane coupling agent (product name: KBM403, formed by Shin-Etsu Chemical Co., Ltd.) having a refractive index of 1.43 and a molecular weight of 236.3 was contained with respect to 100 parts by mass of the liquid crystal compound.

### Comparative Example 2-4

A retardation film was obtained similarly to Example 2-1 except that 5.0 parts by mass of an silane coupling agent (product name: KBE903, formed by Shin-Etsu Chemical Co., Ltd.) having a refractive index of 1.42 and a molecular weight of 221.4 was contained with respect to 100 parts by mass of the liquid crystal compound.

### Comparative Example 2-5

A retardation film was obtained similarly to Example 2-1 except that 0.15 parts by mass of a Si-based leveling agent (product name: BYK323, formed by BYK Corporation) was contained with respect to 100 parts by mass of the liquid crystal compound.

### Comparative Example 2-6

A retardation film was obtained similarly to Example 2-1 except that 5.0 parts by mass of a Si-based leveling agent (product name: BYK323, formed by BYK Corporation) was contained with respect to 100 parts by mass of the liquid crystal compound.

### Comparative Example 2-7

A retardation film was obtained similarly to Example 2-1 except that 0.15 parts by mass of a Si-based leveling agent (product name: KP341, formed by Shin-Etsu Chemical Co., Ltd.) was contained with respect to 100 parts by mass of the liquid crystal compound.

### Comparative Example 2-8

A retardation film was obtained similarly to Example 2-1 except that 5.0 parts by mass of a Si-based leveling agent (product name: KP341, formed by Shin-Etsu Chemical Co., Ltd.) was contained with respect to 100 parts by mass of the liquid crystal compound.

### Comparative Example 2-9

A retardation film was obtained similarly to Example 2-1 except that 1.0 parts by mass of an alkoxysilane (decyltrimethoxysilane) (product name: KBM3103, formed by Shin-Etsu Chemical Co., Ltd.) having a refractive index of 1.42 and a molecular weight of 262.5 was contained with respect to 100 parts by mass of the liquid crystal compound.

### Comparative Example 2-10

A retardation film was obtained similarly to Example 2-1 except that 15.0 parts by mass of an alkoxysilane (decyltrimethoxysilane) (product name: KBM3103, formed by Shin-Etsu Chemical Co., Ltd.) having a refractive index of 1.42 and a molecular weight of 262.5 was contained with respect to 100 parts by mass of the liquid crystal compound.

### Evaluation

The degree of occurrence of interference fringes and an alignment property were evaluated for the retardation films obtained in Examples and Comparative Examples.

A side of the retardation film close to the retardation layer was bonded to a black acrylic board and interference fringes were visually evaluated (appearance evaluation) from the substrate side under a fluorescent light. A mark “⊚” was assigned to those in which the occurrence of interference fringes were suppressed remarkably, a mark “◯” was assigned to those in which the occurrence of interference fringes were suppressed slightly, a mark “Δ” was assigned to those in which there was a few improvement in suppressing the occurrence of interference fringes, and a mark “X” was assigned to those in which there was no improvement in suppressing the occurrence of interference fringes. Further, those assigned with the marks “⊚” and “◯” were evaluated as satisfactory and those assigned with the marks “Δ” and “X” were evaluated as poor.

The alignment property was evaluated based on an in-plane variation in the optical axis in a very small region when the optical axis was measured at 9 measurement sample points using a retardation measurement device (product name: Axostep, formed by Axometrics, Inc.). The variation in the optical axis was defined by the standard deviation (σ) of the optical axis of the measured samples. A mark “⊚” was assigned to those having the σ value (unit: °) smaller than 1.0, a mark “◯” was assigned to those having the σ value of 1.0 or more and smaller than 1.5, a mark “Δ” was assigned to those having the σ value of 1.5 or more and smaller than 2.0, and a mark “X” was assigned to those having the σ value of 2.0 or larger. Further, those assigned with the marks “⊚” and “◯” were evaluated as having a satisfactory alignment property and those assigned with the marks “Δ” and “X” were evaluated as having a poor alignment property.

Table 1 illustrates the compounds added to the pattern alignment layer and the added amounts thereof (the proportion to 100 parts by mass of the photo-alignment material) and the evaluation results on the occurrence of interference fringes and an alignment property of the retardation film.

TABLE 2

| | | | Refractive | Molecular | Added Amount | Interference | Alignment |
|---|---|---|---|---|---|---|---|
| | Added Material | Product Name | Index | Weight | (Parts by mass) | Fringes | Property |
| Example 2-1 | Alkoxysilane | KBM13 | 1.37 | 136.9 | 5.0 | ⊚ | ⊚ |
| | | (Shin-Etsu Chemical) | | | | | |
| Example 2-2 | Alkoxysilane | KBM3103 | 1.42 | 262.5 | 5.0 | ⊚ | ⊚ |
| | | (Shin-Etsu Chemical) | | | | | |
| Example 2-3 | Alkoxysilane | KBM7103 | 1.35 | 218.2 | 5.0 | ⊚ | ◯ |
| | | (Shin-Etsu Chemical) | | | | | |
| Example 2-4 | Alkoxysilane | KBM3103 | 1.42 | 262.5 | 3.0 | ◯ | ⊚ |
| | | (Shin-Etsu Chemical) | | | | | |
| Example 2-5 | Alkoxysilane | KBM3103 | 1.42 | 262.5 | 7.0 | ⊚ | ⊚ |
| | | (Shin-Etsu Chemical) | | | | | |
| Example 2-6 | Alkoxysilane | KBM3103 | 1.42 | 262.5 | 10.0 | ◯ | ⊚ |
| | | (Shin-Etsu Chemical) | | | | | |
| Comparative | Acrylic Monomer | LINC-162A | 1.39 | 570.3 | 5.0 | X | Δ |
| Example 2-1 | | (Kyoeisha Chemical) | | | | | |
| Comparative | Acrylic Monomer | Light Ester M-3F | 1.45 | 114.1 | 5.0 | X | ⊚ |
| Example 2-2 | | (Kyoeisha Chemical) | | | | | |
| Comparative | Silane Coupling Agent | KBM403 | 1.43 | 236.3 | 5.0 | Δ | Δ |
| Example 2-3 | | (Shin-Etsu Chemical) | | | | | |
| Comparative | Silane Coupling Agent | KBE903 | 1.42 | 221.4 | 5.0 | Δ | Δ |
| Example 2-4 | | (Shin-Etsu Chemical) | | | | | |
| Comparative | Si-Based Leveling Agent | BYK323 | — | — | 0.15 | X | ⊚ |
| Example 2-5 | | (BYK Corporation) | | | | | |
| Comparative | Si-Based Leveling Agent | BYK323 | — | — | 5.0 | X | X |
| Example 2-6 | | (BYK Corporation) | | | | | |
| Comparative | Si-Based Leveling Agent | KP341 | — | — | 0.15 | X | ⊚ |
| Example 2-7 | | (Shin-Etsu Chemical) | | | | | |
| Comparative | Si-Based Leveling Agent | KP341 | — | — | 5.0 | X | X |
| Example 2-8 | | (Shin-Etsu Chemical) | | | | | |
| Comparative | Alkoxysilane | KBM3103 | 1.42 | 262.5 | 1.0 | Δ | ⊚ |
| Example 2-9 | | (Shin-Etsu Chemical) | | | | | |
| Comparative | Alkoxysilane | KBM3103 | 1.42 | 262.5 | 15.0 | Δ | Δ |
| Example 2-10 | | (Shin-Etsu Chemical) | | | | | |

As illustrated in the results of Examples in Table 1, in the retardation films of Examples 2-1 to 2-6 in which an alkoxysilane (refractive index: 1.35 to 1.42) was contained in the retardation layer, the occurrence of interference fringes were effectively suppressed and the alignment property was satisfactory.

On the other hand, in Comparative Examples 2-1 and 2-2 in which an acrylic monomer was contained in the retardation layer instead of the alkoxysilane, it can be understood that, even when the absolute refractive index is around 1.4 which is equivalent to that of the alkoxysilane, it was not possible to suppress the occurrence of interference fringes. Moreover, it can be understood that, even when a silane coupling agent or a Si-based leveling agent having an absolute refractive index equivalent to that of the alkoxysilane was contained in the retardation layer (Comparative Examples 2-3 to 2-8), it was not possible to effectively suppress the occurrence of interference fringes. Moreover, it can be understood that, when these leveling agents and the like were added in the same amount (approximately 5.0 parts by mass) as the alkoxysilane in Examples, alignment were not realized.

Further, it can be understood that, even when an alkoxysilane (refractive index: 1.42) was contained in the retardation layer, if the content thereof was 1.0 parts by mass and 15.0 parts by mass (Comparative Examples 2-9 and 2-10), the effect of suppressing the occurrence of interference fringes were small, and the alignment property deteriorated if the content was too large.

### Third Embodiment

### 1. Configuration of Patterned Retardation Film

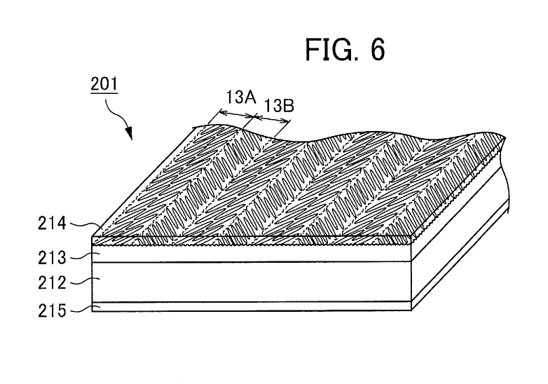

FIG. 6 is a diagram illustrating an example of a patterned retardation film 201 according to a third embodiment of the present invention. In this embodiment, the patterned retardation film 201 forms an image display device and a 3D image display system.

Here, the patterned retardation film 1 includes an alignment layer 213 and a retardation layer 214 which are formed sequentially on one surface of a substrate 212. Although not illustrated in the drawing, a pressure-sensitive adhesive layer and a separator film may be stacked additionally as necessary. In this case, when the separator film is removed, the pressure-sensitive adhesive layer is exposed, and the patterned retardation film 1 is held by being bonded to a panel surface of an image display panel by the pressure-sensitive adhesive layer.

In the present invention, an acrylic transparent substrate such as PMMA is preferably used as the substrate 212. The refractive index of the acrylic transparent substrate is approximately between 1.40 and 1.60. The acrylic transparent substrate is a material of which the refractive index exhibits no change in a thickness direction of the substrate and the dependence on humidity of a dimensional contraction factor is low. Thus, it is possible to reduce the film thickness as compared to TAC and to increase the viewing angle of a 3D panel. The thickness of the acrylic transparent substrate film is preferably 120 μm or smaller, and more preferably 100 μm or smaller, and particularly preferably, 80 μm or smaller. However, as the film thickness decreases, interference fringes between the retardation layer and the transparent substrate is likely to be visible.

In the patterned retardation film 1, the retardation layer 214 is formed by a liquid crystal material that is solidified (cured) in a state of maintaining a refractive index anisotropy and the alignment of the liquid crystal material is patterned by the alignment regulation force of the alignment layer 213. In FIG. 6, the alignment of liquid crystal molecules is exaggerated by narrow ellipses. With this patterning, the patterned retardation film 1 has a right-eye region (a first region or a first retardation region) 13A and a left-eye region (a second region or a second retardation region) 13B which have a predetermined width and are sequentially and alternately formed in a stripe shape so as to correspond to the allocation of pixels in the liquid crystal display panel, and the patterned retardation film 1 gives retardations corresponding to the output beams from the right-eye and left-eye pixels.

In the patterned retardation film 1, after a photo-alignment material layer is formed using a photo-alignment material, for example, the photo-alignment material layer is irradiated with linearly polarized UV light according to a so-called photo-alignment method, whereby the alignment layer 213 is formed according to the photo-alignment method. Here, the UV light irradiated to the photo-alignment material layer is set such that the polarization direction in the right-eye region 13A is different by 90° from that of the left-eye region 13B. In this way, the liquid crystal molecules of the liquid crystal material provided in the retardation layer 214 are aligned in the directions corresponding to the right-eye region 13A and the left-eye region 13B and a retardation corresponding to the transmission light is provided. Various photo-alignment materials to which a photo-alignment method can be applied can be used. In this embodiment, a photodimerizable material of which the alignment does not change with irradiation of UV light after the alignment is realized is used. Examples of the photodimerizable material are disclosed in “M. Schadt, K. Schmitt, V. Kozinkov and V. Chigrinov: Jpn. J. Appl. Phys., 31, 2155 (1992)”, “Schadt, H. Seiberle and A. Schuster: Nature, 381, 212 (1996)”, and the like, and for example, is commercially available by the product name “ROP-103” (manufactured by Rolic technologies Ltd.).

Examples of a polymerizable liquid crystal used in the retardation layer include a liquid crystal having a polymerizable functional group which polymerizes by the action of an ionizing radiation such as UV light or electron beams, or heat. Representative examples of these polymerizable functional groups include a radical polymerizable functional group, a cationic polymerizable functional group, and the like. Representative examples of the radical polymerizable functional group include a functional group having at least one addition-polymerizable ethylenically unsaturated double bond. Specific examples thereof include a vinyl group with or without a substituent, an acrylate group (a generic term of an acryloyl group, a methacryloyl group, an acryloyloxy group, and a methacryloyloxy group), and the like. In addition, specific examples of the cationic polymerizable functional group include an epoxy group and the like. Other examples of the polymerizable functional groups include an isocyanate group, an unsaturated triple bond, and the like. Among these polymerizable functional groups, a functional group having an ethylenically unsaturated double bond is ideally used because of advantages in process.

Particularly preferably, the liquid crystal material has a polymerizable functional group at an end. By using such a liquid crystal compound, it is possible to polymerize the liquid crystal material three-dimensionally to create a state of a mesh (network), for example. Thus, it is possible to form the patterned retardation film having thermal stability and exhibiting an excellent optical property. In the present invention, even when a liquid crystal material having a polymerizable functional group at only one end is used, it is possible to allow the liquid crystal molecules to cross-link with other molecules and to provide the arrangement stability.

Further, in this embodiment, the patterned retardation film 1 has an antireflection layer 215 which is sequentially formed on the other surface of the substrate 212. Although not illustrated in the drawing, a protective film may be formed on the antireflection layer 215 as necessary. The protective film is provided so as to prevent the antireflection layer 215 from adhering to other portions during the production processes and to prevent a scratch on the patterned retardation film 1 during the production and transportation processes. A film that is transparent and has a small alignment property is used as the protective film so that the film does not become a hindrance to the subsequent optical property (defect) examination step. More specifically, a polyethylene film, a PET (polyethylene terephthalate) film, and the like can be used.

The antireflection layer 215 of the present invention is a clear antireflection layer of which the haze value based on JIS K7105 is 0.5% or smaller. The antireflection layer 215 preferably has reflectance (Y value) of 2% or smaller. A hard coat layer or the like may be further stacked between the substrate and the low reflectance layer. Unlike an antiglare layer (also referred to as antiglare (AG) and generally having a haze value of 1.0% or higher) which is another example of an antireflection layer as described above, since the clear antireflection layer has a low haze value, interference fringes is easily visible. The haze value in the present invention is a value measured in a state in which an antireflection layer is stacked on a transparent substrate, and the haze value of the transparent substrate itself is approximately 0.5% or smaller. In the present invention, the haze value of the patterned retardation film 1 is preferably 0.5% or smaller.

The clear antireflection layer is not particularly limited and may be selected from the clear antireflection layers disclosed in Patent Documents 3 and 4 having the haze value of 0.5% or smaller. As commercially available products, Clear LR CV-LC (manufactured by Fuji Film Corporation) which uses a TAC substrate, ReaLook (manufactured by NOF Corporation), and the like can be used.

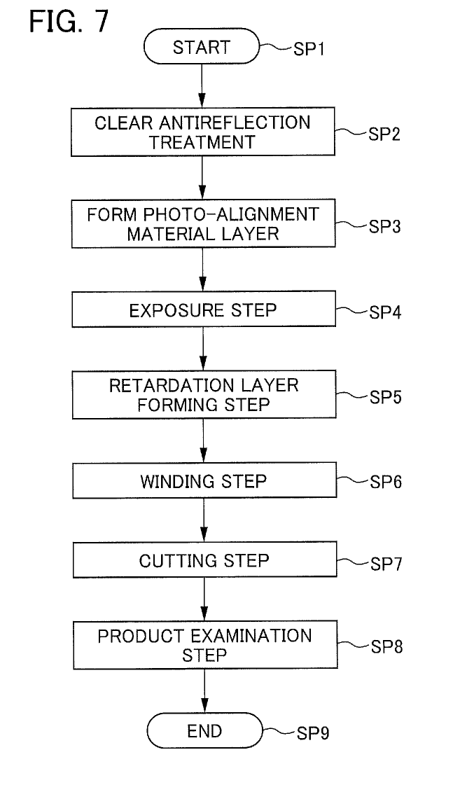

FIG. 7 is a flowchart illustrating the steps of manufacturing the patterned retardation film 1. The steps of manufacturing the patterned retardation film 1 include providing the substrate 212 by a long film wound around a roll, pulling the substrate 212 from the roll to sequentially perform antireflection treatment to form the clear antireflection layer 215 (SP1 to SP2). Subsequently, the manufacturing steps include winding the substrate 212 on a roll and transporting the substrate 212 to an alignment layer forming step or transporting the substrate 212 to a photo-alignment layer forming step and sequentially forming the photo-alignment material layer (SP3). Here, although the photo-alignment material layer can be formed according to various manufacturing methods, in this embodiment, the photo-alignment material layer is formed by coating a coating solution in which a photo-alignment material is dispersed in a solvent such as benzene using a die or the like and then drying the solution.

Subsequently, the manufacturing steps include an exposure step of irradiating the photo-alignment material layer with UV light to form the photo-alignment layer 213 (SP4). Here, the exposure step is executed by selectively exposing a region corresponding to the right-eye region or the left-eye region by irradiation of linearly polarized UV light using a mask and irradiating the entire surface with linearly polarized UV beams of which the polarization directions are orthogonal.

Subsequently, the manufacturing step includes a retardation layer forming step of coating a coating solution of a liquid crystal material using a die or the like and curing the liquid crystal material by irradiation of UV light to form the retardation layer 214 (SP5). Subsequently, in a winding step (SP6), the substrate 212 including the clear antireflection layer 215, the alignment layer 213, and the retardation layer 214 is wound around a roll. In this way, an intermediate product of a patterned retardation film which is an optical film is obtained.

The manufacturing steps include transporting the roll which is the intermediate product to a cutting step and cutting the roll into a desired size to form the patterned retardation film 1 (SP7). The patterned retardation film 1 may be integrated with a linearly polarizing plate disposed on an output surface side of a liquid crystal display panel and be supplied to the steps of manufacturing the liquid crystal display panel. In this case, an optical functional layer related to the linearly polarizing plate is formed on the substrate 212 pulled from the roll, and then the substrate 212 is cut into a desired size in the cutting step. Moreover, a polarizer or the like may be disposed on the panel surface of the liquid crystal display panel using an adhesive layer or a UV-adhesive. In this case, an adhesive layer, a separator film, or the like is formed on the substrate 212 pulled from the roll and the substrate 212 is cut into a desired size in the cutting step. The manufacturing steps includes a product examination step of examining the patterned retardation film 1 manufactured in this manner, and the examined patterned retardation films are forwarded for shipment (SP8 to SP9).

### Configuration of Retardation Layer

In the present invention, the retardation layer 214 contains a polymerizable liquid crystal obtained by polymerizing a polymerizable liquid crystal material and fine particles having a predetermined refractive index. Here, as described above, the refractive index of the transparent substrate 212 is approximately between 1.45 and 1.55 (the refractive index of the acrylic transparent substrate is approximately 1.50 and the refractive index of the TAC substrate is 1.48). On the other hand, the refractive index of the polymerizable liquid crystal is as high as approximately between 1.55 and 1.75. Due to the difference in refractive index, interference fringes occur due to a thin film interference between the retardation layer and the transparent substrate.

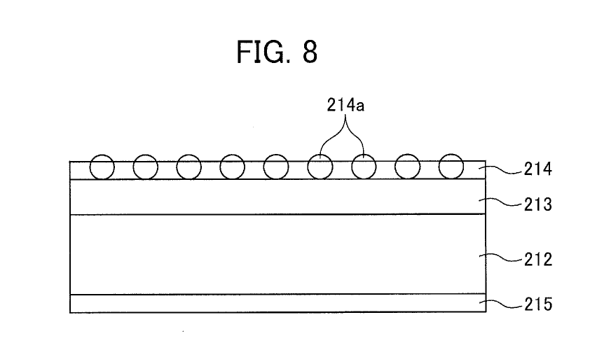

Thus, as illustrated in FIG. 8 which is an enlarged cross-sectional view of FIG. 6, in the present invention, the retardation layer 214 contains fine particles 214a having a lower refractive index than the refractive index of the polymerizable liquid crystal. By doing so, the refractive index of the retardation layer is decreased to suppress the interference fringes. The refractive index of the fine particles is preferably between 1.3 and 1.7. If the refractive index is smaller than 1.3, it is undesirable because the difference from the refractive index of the retardation layer is large, cloudiness is likely to appear due to internal scattering. If the refractive index exceeds 1.7, it is undesirable because it is difficult to adjust the refractive index. A refractive index difference from the transparent substrate (that is, (refractive index of transparent substrate)−(average refractive index of retardation layer)) is preferably between 0.01 and 0.1 in order to suppress the interference fringes.

When an average particle size of the fine particles 214a is set to be larger than the thickness of the retardation layer, it is possible to form an uneven surface on the surface of the retardation layer 214 to suppress interference fringes. Specifically, the uneven surface is preferably formed such that an average thickness of the portion of the retardation layer 214 excluding fine particles is between 0.7 μm and 1.3 μm and the average particle size of the fine particles 214a is between 1.0 μm and 2.0 μm. The difference between the average thickness of the portion of the retardation layer 214 excluding fine particles and the average particle size of the fine particle 214a is preferably between 0.3 μm and 1.3 μm.

The fine particle is not particularly limited, and silica, alumina, zirconia, gold, zinc oxides, and the like can be used. Among these materials, silica and hollow silica are preferably used from the perspective of the cost, durability, and refractive index.

The content of the fine particles in the retardation layer 214 is preferably 0.01 mass % or more from the perspective of interference fringes and blocking properties and 10 mass % or smaller from the perspective of the haze value and liquid crystal alignment properties.

With the fine particles contained, the surface roughness Ra of the uneven surface of the retardation layer 214 is preferably between 3 nm and 200 nm, and more preferably between 5 nm and 150 nm.

### Another Example of Third Embodiment

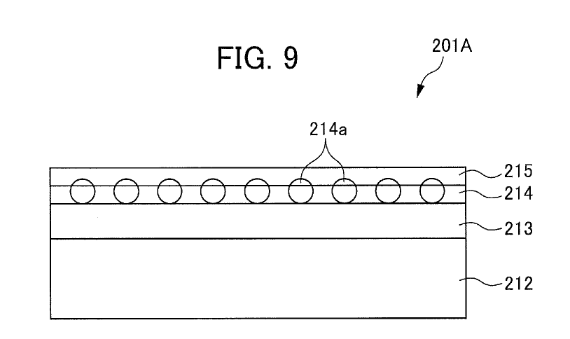

In the third embodiment, although the patterned retardation film 1 in which the antireflection layer 215, the transparent substrate 212, the alignment film 3, and the retardation layer 214 that contains polymerizable liquid crystals are stacked in that order has been described, the present invention is not limited to this. As another embodiment, as illustrated in the enlarged cross-sectional view in FIG. 9, a patterned retardation film 201A may have the antireflection layer 215, the retardation layer 214 that contains polymerizable liquid crystals, the alignment film 3, and the transparent substrate 212 which are stacked in that order.

In such a patterned retardation film 1A, the respective layers may have the same configuration as those of the first embodiment. That is, the antireflection layer 215 is a clear antireflection layer of which the haze value based on JIS K7105 is 0.5% or smaller, and the reflectance (Y value) thereof is preferably 2% or smaller. Moreover, the retardation layer 214 contains polymerizable liquid crystals obtained by polymerizing a polymerizable liquid crystal material and the fine particles 214a having a lower refractive index than the refractive index of the polymerizable liquid crystals. According to the patterned retardation film 1A having such a configuration, it is possible to decrease the refractive index of the retardation layer to effectively suppress interference fringes.

A method of manufacturing the patterned retardation film 1A will be described. First, a photo-alignment material layer is formed on the substrate 212 provided from a long film wound around a roll and is irradiated with UV light in an exposure step to form the photo-alignment layer 213. Subsequently, a liquid crystal material coating solution is coated on the photo-alignment layer, and the liquid crystal material is cured by irradiation of UV light to form the retardation layer 214. Clear antireflection treatment is performed on the retardation layer 214 (the surface opposite to the alignment layer 213) of the patterned retardation film in which the substrate 212, the alignment layer 213, and the retardation layer 214 are sequentially stacked. In this way, the clear antireflection layer 215 is formed. With the above-described method, it is possible to manufacture the patterned retardation film 1A in which the antireflection layer 215, the retardation layer 214 that contains polymerizable liquid crystals, the alignment film 3, and the transparent substrate 212 are stacked in that order.

### Examples

Hereinafter, the present invention will be described in further detail with reference to examples. However, the present invention is not limited to these examples.

### Example 3-1

A patterned retardation film having the configuration illustrated in FIGS. 6 and 8 was manufactured. Here, the substrate 212 and the antireflection layer 215 are a stacked structure (10 μm, haze value: 0.3%) that includes a clear HC (hard coat) and an antireflection layer formed on an acrylic film (40 μm, refractive index: 1.50). A coating solution of the alignment layer 213 (a mixture of a compound (low molecular) (A) having a photo-aligning group and a hydroxy group, a polymer (B), and a crosslinker (C), disclosed in WO2011/126022, applicant: Nissan Chemical Industries Ltd.) was applied to a surface of the transparent substrate opposite to the antireflection layer according to a die coating method and was dried. After that, the transparent substrate was irradiated with a pattern of linearly polarized UV light having an intensity of 20 mJ/cm² to form the alignment layer 213 having a thickness of approximately 0.1 μm. In this case, the linearly polarized light had a polarization axis inclined by an angle of ±45° with respect to the transporting direction MD.

Subsequently, a liquid crystal composition (using MIBK as a diluting solvent) of photo-polymerizable nematic liquid crystals (refractive index of polymerizable liquid crystals only: 1.62, product name: licrivue (registered trademark) RMS03-013C, formed by Merck Corporation) that contain silica fine particles having a refractive index of 1.50 and an average particle size of 1.5 μm in a solid mass percentage of 1% was applied to the alignment film 3 according to a die coating method and was dried. After that, the liquid crystal composition was polymerized by UV irradiation to the retardation layer 214. In this way, a patterned retardation film was obtained.

The refractive index of the entire retardation layer 214 of Example 3-1 was 1.59, and the average thickness of the portion of the retardation layer 214 excluding fine particles was 1 μm.

### Example 3-2

A patterned retardation film was obtained similarly to Example 3-1 except that, in Example 3-1, silica fine particles having a refractive index of 1.45 and an average particle size of 2.0 μm were contained in a solid mass percentage of 0.5%.

The refractive index of the entire retardation layer 214 of Example 3-2 was 1.55, and the average thickness of the portion of the retardation layer 214 excluding fine particles was 1 μm.

### Example 3-3

A patterned retardation film was obtained similarly to Example 3-1 except that, in Example 3-1, hollow silica fine particles having a refractive index of 1.40 and an average particle size of 0.07 μm were contained in a solid mass percentage of 0.1%.

The refractive index of the entire retardation layer 214 of Example 3-3 was 1.53, and the average thickness of the portion of the retardation layer 214 excluding fine particles was 1 μm.

### Example 3-4

A patterned retardation film having the configuration illustrated in the enlarged cross-sectional view of FIG. 9

The patterned retardation film was manufactured similarly to Example 3-1 except that the antireflection layer 215, the retardation layer 214, the alignment film 3, and the transparent substrate 212 were stacked in that order.

Specifically, a coating solution of the alignment layer 213 was applied to a transparent substrate formed of an acrylic film (40 μm, refractive index: 1.50) according to a die coating method and was dried. After that, the transparent substrate was irradiated with a pattern of linearly polarized UV light having an intensity of 20 mJ/cm² to form the alignment layer 213 having a thickness of approximately 0.1 μm. Subsequently, a liquid crystal composition of photo-polymerizable nematic liquid crystals that contain silica fine particles having a refractive index of 1.50 and an average particle size of 1.5 μm in a solid mass percentage of 1% was applied to the alignment film 3 according to a die coating method and was dried. After that, the liquid crystal composition was polymerized by UV irradiation to form the retardation layer 214. In this way, a patterned retardation film was obtained. After that, clear antireflection treatment was performed on the retardation layer 214 of the obtained patterned retardation film to form an antireflection layer and a clear HC (hard coat) (surface material) was stacked thereon to form the patterned retardation film. The materials such as the coating solutions that form the respective layers were the same as those of Example 3-1.

The refractive index of the entire retardation layer 214 of Example 3-4 was 1.59, and the average thickness of the portion of the retardation layer 214 excluding fine particles was 1 μm.

### Comparative Example 3-1

A patterned retardation film was obtained similarly to Example 3-1 except that in Example 3-1, fine particles were not contained.

The refractive index of the entire retardation layer 214 of Comparative Example 3-1 was 1.62, and the average thickness of the retardation layer 214 was 1 μm.

### Test Example

A patterned retardation film was obtained similarly to Example 3-1 except that, in Example 3-1, 15% of fine particles were contained.

The refractive index of the entire retardation layer 214 of Test Example 3-1 was 1.57, and the average thickness of the retardation layer 214 was 1 μm.

### [Evaluation]

The reflectance Y value (%) which is a perceived reflectance of the CIE color system was measured for the patterned retardation films of Examples, Comparative Examples, and Test Example using a spectrophotometer (UV-3100PC) (manufactured by Shimadzu Corporation) when an incidence angle and a reflection angle were 5°. The surface roughness Ra value was evaluated by measuring the uneven surface of the retardation layer using a surface roughness measuring instrument (SE-3400, manufactured by Kosaka Laboratory Ltd.), and a side of the retardation film close to the retardation layer was bonded to a black acrylic board and interference fringes were visually evaluated from the antireflection layer side under a fluorescent light. Moreover, the haze value (%) of the film after the retardation layer was formed was measured using a haze meter (HM-150: manufactured by Murakami Color Research Laboratory Co., Ltd.). The results are illustrated in Table 1.

TABLE 3

| | Average | | | | |
|---|---|---|---|---|---|
| | Refractive | Reflec- | | Inter- | |
| | Index of | tance | | ference | Haze |
| | Retardation | Y Value | Ra | Fringes | Value |
| | Layer | (%) | (nm) | (OK/NG) | (%) |
| Example 3-1 | 1.59 | 1.25 | 5.0 | OK | 0.5 |
| Example 3-2 | 1.55 | 1.20 | 6.0 | OK | 0.4 |
| Example 3-3 | 1.53 | 1.22 | 4.5 | OK | 0.3 |
| Example 3-4 | 1.59 | 1.30 | 1.0 | OK | 0.5 |
| | | | (Surface | | |
| | | | Material) | | |
| Comparative | 1.62 | 1.40 | 2.0 | NG | 0.3 |
| Example 3-1 | | | | | |
| Test Example | 1.57 | 1.23 | 2.0 | OK | 10 |

*The Ra value in Example 3-4 is the Ra value of the surface material laminated on the retardation layer.

From the results of Table 1, it can be understood that the occurrence of interference fringes was suppressed in the patterned retardation film of the present invention in which the refractive index of the retardation layer 214 is close to 1.50 which is the refractive index of the transparent substrate 212. It can be also understood that since the Y value is small, internal scattering is also suppressed in Examples.

### Fourth Embodiment

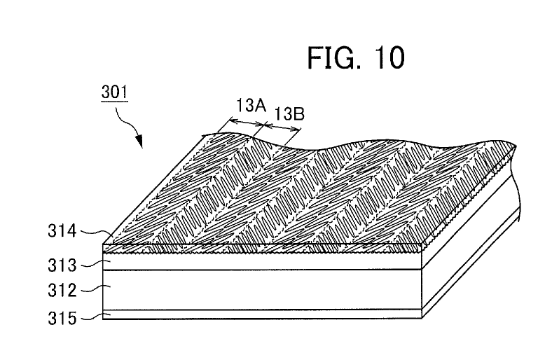

FIG. 10 is a diagram illustrating an example of a retardation film 301 according to a Fourth embodiment of the present invention. In this embodiment, the retardation film 301 forms an image display device and a 3D image display system.

Here, the patterned retardation film 301 includes an alignment layer 313 and a retardation layer 314 which are sequentially formed on one surface of a substrate 312. Although not illustrated in the drawing, a pressure-sensitive adhesive layer and a separator film may be stacked additionally as necessary. In this case, when the separator film is removed, the pressure-sensitive adhesive layer is exposed, and the patterned retardation film 1 is held by being bonded to a panel surface of an image display panel by the pressure-sensitive adhesive layer. Moreover, an antireflection layer 5 is sequentially formed on the other surface of the substrate 312.

In the patterned retardation film 301, the substrate 312, the alignment layer 313, and the antireflection layer 315 have the same configuration as the substrate 212, the alignment layer 213, and the antireflection layer 215 of the patterned retardation film 201 described in the third embodiment. Moreover, the retardation layer 314 has the same configuration as the retardation layer 214 of the patterned retardation film 201 described in the third embodiment except that the alkoxysilane is not contained.

Due to this, in this embodiment, the antireflection layer 315 of the patterned retardation film 301 is formed of a clear antireflection layer having a haze value of 0.5% or smaller. The refractive indices of the respective layers of the patterned retardation film 301 are set so as to satisfy the following conditions.

### Refractive Indices of Respective Layers

In the present invention, when n₁ is the refractive index of the transparent substrate, n₂ is the refractive index of the alignment layer, and n₃ is the refractive index of the retardation layer, the alignment layer is formed such that
n₁<n₂<n₃, and
for n_{AVE}=(n₁+n₃)/2, which is an average value of n₁ and n₃, n_{AVE}+0.01>n₂>n_{AVE}−0.01

That is, the refractive index of the alignment layer is adjusted to approximately an intermediate value between the refractive index of the transparent substrate and the refractive index of the retardation layer. In this way, the occurrence of interference fringes can be suppressed.

The refractive index n₁ of the transparent substrate is approximately 1.50 for an acrylic transparent substrate, approximately 1.48 for a TAC substrate, and is generally between approximately 1.45 and 1.55. On the other hand, the refractive index of the polymerizable liquid crystal is as high as approximately between 1.55 and 1.75. Due to the difference in refractive index, interference fringes occur due to a thin film interference between the retardation layer and the substrate. Thus, in the present invention, the refractive index of the intermediate alignment layer is adjusted to an approximately intermediate value of two layers (specifically, in the range of the intermediate value±0.01).

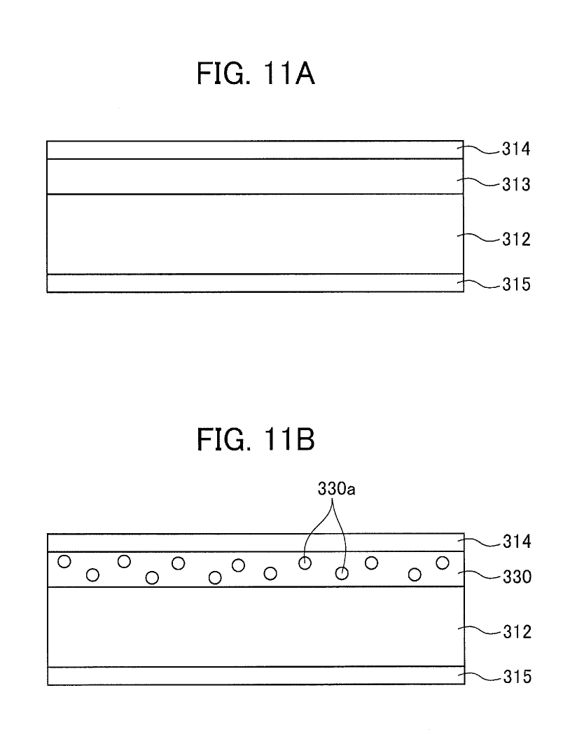

A specific embodiment is illustrated in FIGS. 11A and 11B which are the enlarged cross-sectional views of FIG. 10. FIG. 11A is a first embodiment and FIG. 11B is a second embodiment.

The embodiment illustrated in FIG. 11A selects the refractive index after curing, of a photodimerizable liquid crystal material itself that forms the alignment layer. For example, when the refractive index of an acrylic transparent substrate is 1.50, and the refractive index of the retardation layer is 1.60, a liquid crystal material having the refractive index of the intermediate value 1.55±0.01 is selected. Various polymer materials that form the alignment layer, which have various refractive indices such as a photo-alignment layer which uses azobenzene derivatives having a refractive index of 1.72 (disclosed in Example 1 of Japanese Patent No. 4689201) and a photoreative dendrimer having a refractive index of 1.56 (“ROP-103”, manufactured by Rolic technologies Ltd.), of which the terminal group is hydrogen or a photoreactive group are known. Thus, a refractive index required for the present application can be appropriately selected from these materials.

On the other hand, in the embodiment illustrated in FIG. 11B, an alignment layer 330 contains an additive 330a for adjusting the refractive index in addition to the polymer material. With this embodiment, the refractive index of the entire alignment layer can be adjusted. The refractive index of the additive 330a can be selected appropriately. When the refractive index after curing, of the polymer material itself is higher than a target refractive index n₂, a material having a lower refractive index than the target refractive index may be selected. When the refractive index after curing, of the polymer material itself is lower than the target refractive index n₂, a material having a higher refractive index than the target refractive index may be selected.

The additive is not particularly limited, and silica, alumina, zirconia, gold, zinc oxides, and the like can be used. Among these materials, silica and hollow silica are preferably used from the perspective of the cost, durability, and refractive index.

The average particle size of the additive is preferably 0.5 μm or more from the perspective of adjustment of the refractive index of the retardation layer and 2.5 μm or smaller from the perspective of an alignment property and suppression of the haze value.

The content of fine particles is preferably 0.01 mass % or more from the perspective of adjustment of the refractive index (interference fringes) and 10 mass % or smaller from the perspective of the haze value and liquid crystal alignment properties.

### Another Example of Fourth Embodiment

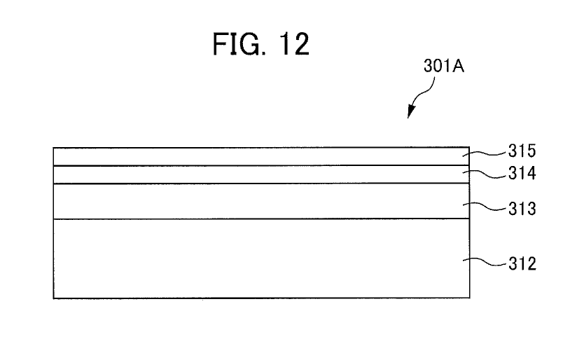

In the Fourth Embodiment, Although the Patterned retardation film 301 in which the antireflection layer 315, the transparent substrate 312, the alignment layer 313, and the retardation layer 314 that contains the polymerizable liquid crystals are stacked in that order has been described, the present invention is not limited to this. As another embodiment, as illustrated in the enlarged cross-sectional view in FIG. 12, a patterned retardation film 301A may have the antireflection layer 315, the retardation layer 314 that contains the polymerizable liquid crystals, the alignment layer 313, and the transparent substrate 312 which are stacked in that order.

In such a patterned retardation film 301A, the respective layers may have the same configuration as those of the first embodiment. That is, the antireflection layer 315 is a clear antireflection layer of which the haze value based on JIS K7105 is 0.5% or smaller, and the reflectance (Y value) thereof is preferably 2% or smaller. Regarding the refractive indices of the respective layers, when n₁ is the refractive index of the transparent substrate, n₂ is the refractive index of the alignment layer, and n₃ is the refractive index of the retardation layer, the alignment layer is formed such that
n₁<n₂<n₃, and
for n_{AVE}=(n₁-n₃)/2, which is an average value of n₁ and n₃, n_{AVE}+0.01>n₂>n_{AVE}−0.01

That is, according to the patterned retardation film 301A having such a configuration, the refractive index of the alignment layer is set to approximately an intermediate value between the refractive index of the transparent substrate and the refractive index of the retardation layer. In this way, the occurrence of interference fringes can be suppressed effectively.

A method of manufacturing the patterned retardation film 301A will be described. First, a photo-alignment material layer is formed on the substrate 312 provided from a long film wound around a roll and is irradiated with UV light in an exposure step to form the photo-alignment layer 313. Subsequently, a liquid crystal material coating solution is coated on the photo-alignment layer, and the liquid crystal material is cured by irradiation of UV light to form the retardation layer 314. Clear antireflection treatment is performed on the retardation layer 314 (the surface opposite to the alignment layer 313) of the patterned retardation film in which the substrate 312, the alignment layer 313, and the retardation layer 314 are sequentially stacked. In this way, the clear antireflection layer 315 is formed. With the above-described method, it is possible to manufacture the patterned retardation film 301A in which the antireflection layer 315, the retardation layer 314 that contains polymerizable liquid crystals, the alignment layer 313, and the transparent substrate 312 are stacked in that order.

### Examples

### Example 4-1

A patterned retardation film having the configuration illustrated in FIG. 11A was manufactured. Here, the substrate 312 and the antireflection layer 315 are a stacked structure (10 μm, product name: ReaLook, reflectance: 1.0%, manufactured by NOF Corporation) including a clear HC (hard coat) and an antireflection layer formed on an acrylic film (40 μm, refractive index: 1.50). A coating solution of the alignment layer 313 (refractive index: 1.56, product name: “ROP-103”, manufactured by Rolic technologies Ltd.) was applied to a surface of the transparent substrate opposite to the antireflection layer according to a die coating method and was dried. After that, the transparent substrate was irradiated with a pattern of linearly polarized UV light having an intensity of 20 mJ/cm² to form the alignment layer 313 having a thickness of approximately 0.1 μm. In this case, the linearly polarized light had a polarization axis inclined by an angle of ±45° with respect to the transporting direction MD.

Subsequently, a liquid crystal composition (using MIBK as a diluting solvent) of photo-polymerizable nematic liquid crystals (refractive index of polymerizable liquid crystals only: 1.60) was applied to the alignment film 313 according to a die coating method and was dried. After that, the liquid crystal composition was polymerized by UV irradiation to obtain the retardation layer 314 having a thickness of 1 μm. In this way, a patterned retardation film was obtained.

### Example 4-2

A patterned retardation film was obtained similarly to Example 4-1 except that, in Example 4-1, a photodimerizable polymer material having a refractive index of 1.52 was used, and alumina fine particles having a refractive index of 1.57 and an average particle size of 1.5 μm were contained in the polymer material in a mass percentage of 1% as refractive index-adjustment fine particles to adjust the refractive index of the entire alignment layer to 1.54.

### Example 4-3

A patterned retardation film having the configuration illustrated in the enlarged cross-sectional view of FIG. 12 was manufactured. That is, the patterned retardation film was manufactured similarly to Example 4-1 except that, the antireflection layer 315, the retardation layer 314, the alignment layer 313, and the transparent substrate 312 were stacked in that order.

Specifically, a coating solution of the alignment layer 313 (refractive index: 1.56) was applied to a transparent substrate formed of an acrylic film (40 μm, refractive index: 1.50) according to a die coating method and was dried. After that, the transparent substrate was irradiated with a pattern of linearly polarized UV light having an intensity of 20 mJ/cm² to form the alignment layer 313 having a thickness of approximately 0.1 μm. Subsequently, a liquid crystal composition of photo-polymerizable nematic liquid crystals (refractive index of polymerizable liquid crystals only: 1.60) was applied to the alignment film 313 according to a die coating method and was dried. After that, the liquid crystal composition was polymerized by UV irradiation to obtain the retardation layer 314 having a thickness of 1 μm. In this way, a patterned retardation film was obtained. After that, clear antireflection treatment was performed on the retardation layer 314 of the obtained patterned retardation film to form an antireflection layer and a clear HC (hard coat) (surface material) was stacked thereon to form the patterned retardation film. The materials such as the coating solutions that form the respective layers were the same as those of Example 4-1.

### Comparative Example 4-1

A patterned retardation film was obtained similarly to Example 4-1 except that, in Example 4-1, a liquid crystal composition (using MIBK as a solvent) of photo-polymerizable nematic liquid crystals (refractive index of polymerizable liquid crystals only: 1.58) was used solely to form the retardation layer 314.

### Comparative Example 4-2

A patterned retardation film was obtained similarly to Example 4-1 except that in Example 4-2, 15% of fine particles were contained in the alignment layer.

The refractive index of the entire alignment layer of Comparative Example 4-2 was 1.52.

### [Evaluation]

The reflectance Y value (%) which is a perceived reflectance of the CIE color system was measured for the patterned retardation films of Examples and Comparative Examples using a spectrophotometer (UV-3100PC) (manufactured by Shimadzu Corporation) when an incidence angle and a reflection angle were 5°. A side of the retardation film close to the retardation layer was bonded to a black acrylic board and interference fringes were visually evaluated from the antireflection layer side under a fluorescent light. The results are illustrated in Table 1.

TABLE 4

| | | Average | | | |
|---|---|---|---|---|---|
| | Refractive | Refractive | Refractive | Reflec- | |
| | Index of | Index of | Index of | tance | Inter- |
| | Transparent | Alignment | Retardation | Y Value | ference |
| | Substrate | Film | Layer | (%) | Fringes |
| Example 4-1 | 1.50 | 1.56 | 1.60 | 1.25 | OK |
| Example 4-2 | 1.50 | 1.54 | 1.60 | 1.20 | OK |
| Example 4-3 | 1.50 | 1.55 | 1.59 | 1.30 | OK |
| Comparative | 1.50 | 1.57 | 1.58 | 1.42 | NG |
| Example 4-4 | | | | | |
| Comparative | 1.50 | 1.52 | 1.60 | 2.10 | NG |
| Example 4-2 | | | | | |

From the results of Table 4, it can be understood that the occurrence of interference fringes was suppressed in the patterned retardation film of the present invention in which the refractive index of the alignment layer 313 is close to 1.55 which is the intermediate value between the refractive index 1.50 of the transparent substrate 312 and the refractive index 1.60 of the retardation layer 314. It can be also understood that since the Y value is small, internal scattering is also suppressed in Examples.

### Other Embodiments

While specific configurations ideal for implementation of the present invention have been described, various changes can be made in the configuration of the embodiments without departing from the spirit and scope of the present invention.

That is, in the above-described embodiments, although the right-eye and left-eye pixels are set sequentially in the vertical direction to form the first and second regions in a stripe form, the present invention is not limited to this. The present invention can be broadly applied to a case in which the right-eye and left-eye pixels may be allocated in the vertical and horizontal directions so that the first and second regions are set according to an arrangement of the checkered pixel patterns.

Moreover, in the above-described embodiments, although the alignment layer is formed according to a photo-alignment method, the present invention is not limited to this. The present invention can be broadly applied to a case in which fine uneven shapes are formed according to a molding process to form the alignment layer.

Moreover, in the above-described embodiments, although the retardation film is disposed in an image display panel formed of a liquid crystal display panel, the present invention is not limited to this. The present invention can be broadly applied to a case in which the retardation film is disposed in an image display panel formed of an organic EL device and an image display panel formed of a plasma display. In this case, an output beam from these image display panels may be converted to a linearly polarized beam by a linearly polarizing plate and pass through a patterned retardation film. The linearly polarizing plate and the patterned retardation film may be bonded to provide the patterned retardation film so as to include the linearly polarizing plate.

Moreover, in the above-described embodiments, although the present invention is applied to a patterned retardation film which is a retardation film having a patterned retardation layer, the present invention is not limited to this. The present invention can be broadly applied to various A-plates such as a ¼-wavelength plate or a ½-wavelength plate, in which the retardation layer is not patterned. Moreover, in such an A-plate, the patterned retardation film may be applied to an image display device in combination with a linearly polarizing plate like a circularly polarizing plate, for example. In this case, the linearly polarizing plate may be bonded to a retardation film that forms the A-plate or the like to provide a polarizing plate so as to include the retardation film.

### EXPLANATION OF REFERENCE NUMERALS

1, 101, 201, 301: Patterned retardation film
11, 111, 212, 312: Substrate
12, 112, 213, 313, 330: Alignment layer
13, 113, 214, 314: Retardation layer
214a: Fine particle
215, 315: Antireflection layer
330a: Additive

1. A retardation film comprising:
a substrate, an alignment layer that contains a photo-alignment material, and a retardation layer that contains a liquid crystal compound, wherein
the alignment layer contains an epoxy monomer having a refractive index of 1.60 or more in a proportion of between 3.0 parts by mass and 8.0 parts by mass with respect to 100 parts by mass of the photo-alignment material.

2. The retardation film according to claim 1, wherein
the refractive index of the epoxy monomer is 1.70 or more.

3. The retardation film according to claim 1, wherein
an in-plane variation of an optical axis defined by a standard deviation (σ) when the optical axis was measured is smaller than 1.5.

4. The retardation film according to claim 1, wherein
the alignment layer has an alignment pattern.

5. A polarizing plate comprising the retardation film according to claim 1.

6. An image display device comprising the retardation film according to claim 1.

7. A 3D image display system comprising the image display device according to claim 6.

8. A method for manufacturing a retardation film including a substrate, an alignment layer that contains a photo-alignment material, and a retardation layer that contains a liquid crystal compound, wherein
the alignment layer is formed by coating an alignment layer composition that contains an epoxy monomer having a refractive index of 1.60 or more in a proportion of between 3.0 parts by mass and 8.0 parts by mass with respect to 100 parts by mass of the photo-alignment material on the substrate and curing the alignment layer composition.

9. A retardation film comprising:
a substrate, an alignment layer, and a retardation layer that contains a liquid crystal compound, wherein
the retardation layer contains an alkoxysilane in a proportion of between 2.0 parts by mass and 14.0 parts by mass with respect to 100 parts by mass of the liquid crystal compound.

10. The retardation film according to claim 9, wherein
the refractive index of the alkoxysilane is 1.50 or smaller.

11. The retardation film according to claim 9, wherein
an in-plane variation of an optical axis defined by a standard deviation (σ) when the optical axis was measured is smaller than 1.5.

12. The retardation film according to claim 9, wherein
the alignment layer has an alignment pattern.

13. A polarizing plate comprising the retardation film according to claim 9.

14. An image display device comprising the retardation film according to claim 9.

15. A 3D image display system comprising the image display device according to claim 14.

16. A method for manufacturing a retardation film including a substrate, an alignment layer, and a retardation layer that contains a liquid crystal compound, wherein
the retardation layer is formed by coating a liquid crystal composition that contains an alkoxysilane in a proportion of between 2.0 parts by mass and 14.0 parts by mass with respect to 100 parts by mass of the liquid crystal compound on the alignment layer and curing the liquid crystal composition.

17. A retardation film in which an antireflection layer, a transparent substrate, an alignment layer, and a retardation layer that contains polymerizable liquid crystals are sequentially stacked in that order, and the retardation layer provides a retardation to transmission light, wherein
the antireflection layer is a clear antireflection layer of which the haze value based on JIS K7105 is 0.5% or smaller, and
the retardation layer contains fine particles having a refractive index lower than a refractive index of the polymerizable liquid crystals.

18. The retardation film according to claim 17, wherein
the refractive index of the fine particles is between 1.3 and 1.7.

19. The retardation film according to claim 17, wherein
an average particle size of the fine particles is larger than a thickness of the retardation layer.

20. The retardation film according to claim 17, wherein
the fine particles are silica, and a content of the fine particles in the retardation layer is between 0.01 mass % and 10 mass %.

21. The retardation film according to claim 17, wherein
a surface roughness Ra of the retardation layer is between 3 nm and 200 nm.

22. The retardation film according to claim 17, wherein
the transparent substrate is an acrylic resin and has a thickness of 80 μm or smaller.

23. The retardation film according to claim 17, wherein
the alignment layer has an alignment pattern.

24. A polarizing plate comprising the retardation film according to claim 17.

25. An image display device comprising the retardation film according to claim 17.

26. A 3D image display system comprising an image display device according to claim 25.

27. A retardation film in which an antireflection layer, a retardation layer that contains polymerizable liquid crystals, an alignment layer, and a transparent substrate are sequentially stacked in that order, and the retardation layer provides a retardation to transmission light, wherein
the antireflection layer is a clear antireflection layer of which the haze value based on JIS K7105 is 0.5% or smaller, and
the retardation layer contains fine particles having a refractive index lower than a refractive index of the polymerizable liquid crystals.

28. A retardation film in which an antireflection layer, a transparent substrate, an alignment layer, and a retardation layer that contains polymerizable liquid crystals are sequentially stacked in that order, and the retardation layer provides a retardation to transmission light, wherein
the antireflection layer is a clear antireflection layer of which the haze value based on JIS K7105 is 0.5% or smaller, and
when n₁ is the refractive index of the transparent substrate, n₂ is the refractive index of the alignment layer, and n₃ is the refractive index of the retardation layer,
n₁<n₂<n₃, and
for n_{AVE}=(n₁+n₃)/2, which is an average value of n₁ and n₃, n_{AVE}+0.01>n₂>n_{AVE}−0.01.

29. The retardation film according to claim 28, wherein
the transparent substrate is an acrylic resin having a thickness of 80 μm or smaller.

30. The retardation film according to claim 28, wherein
the refractive index n₂ of the alignment layer is between 1.53 and 1.56.

31. The retardation film according to claim 28, wherein
the alignment layer is formed of a photodimerizable polymer material.

32. The retardation film according to claim 28, wherein
the alignment layer contains a photodimerizable polymer material and an additive for adjusting a refractive index.

33. The retardation film according to claim 28, wherein
the alignment layer has an alignment pattern.

34. A polarizing plate comprising the retardation film according to claim 28.

35. An image display device comprising the retardation film according to claim 28.

36. A 3D image display system comprising the image display device according to claim 35.

37. A retardation film in which an antireflection layer, a retardation layer that contains polymerizable liquid crystals, an alignment layer, and a transparent substrate are sequentially stacked in that order, and the retardation layer provides a retardation to transmission light, wherein
the antireflection layer is a clear antireflection layer of which the haze value based on JIS K7105 is 0.5% or smaller, and
when n₁ is the refractive index of the transparent substrate, n₂ is the refractive index of the alignment layer, and n₃ is the refractive index of the retardation layer,
n₁<n₂<n₃, and
for n_{AVE}=(n₁+n₃)/2, which is an average value of n₁ and n₃, n_{AVE}+0.01>n₂>n_{AVE}−0.01.
